(19) United States
(12) Patent Application Publication
(10) Pub. No.: US 2013/0068797 A1
(43) Pub. Date: Mar. 21, 2013

(54) MANUAL PUMP TYPE FLUID DISPENSER

(71) Applicants: Keith Laidler, Stourbridge (GB); Timothy Rodd, Lyndhurst (GB)

(72) Inventors: Keith Laidler, Stourbridge (GB); Timothy Rodd, Lyndhurst (GB)

(73) Assignee: LEAFGREEN, LTD., Wollaston, Stourbridge, West Midlands (GB)

(21) Appl. No.: 13/518,334

(22) PCT Filed: Dec. 17, 2010
(86) PCT No.: PCT/GB2010/052141

§ 371 Date: Nov. 27, 2012

(30) Foreign Application Priority Data
Dec. 23, 2009 (GB) 0922580.6
Apr. 14, 2010 (GB) 1006152.1
May 13, 2010 (GB) 2010/050780
Oct. 20, 2010 (GB) 1017662.6

(51) Int. Cl. B65D 88/54; B67D 7/58; G01F 11/00

(52) U.S. Cl. 222/321.1; 222/321.6; 222/321.8; 222/383.1

(57) ABSTRACT

A manually actuated pump type fluid dispenser has a casing (118) defining an internal cavity and a pump member (101) at least partly located in the cavity. The pump member has a central core (101)a and first and second seal members (101b, 101c) projecting radially outwardly of the core and spaced in an axial direction of the core for contact with the casing to define a pump chamber within the cavity. A region (112) of the core between the first and second seal members is resiliently deformable from an initial resiliently biased configuration in which the first and second seal members are axially spaced by a first amount and an axially compressed configuration in which the seal members are spaced by a second amount which is less than the first amount to reduce the volume of the pump chamber.

The present invention relates to manually actuated pump type fluid dispensers including those operated by a trigger or handle.

Manually actuated pump type fluid dispensers are commonly used to provide a means by which fluids can be dispensed from a non-pressurised container. Typically, dispensers of this kind have a pump arrangement which is located above the container when in use. The pump includes a pump chamber connected with the container by means of an inlet having an inlet valve and with a dispensing outlet via an outlet valve. To actuate the dispenser, a user manually applies a force to an actuator to reduce the volume of the pump chamber and pressurise the fluid inside. Once the pressure in the chamber reaches a pre-determined value, the outlet valve opens and the fluid is expelled through the outlet. When the user removes the actuating force, the volume of the chamber increases and the pressure in the chamber falls. This closes the outlet valve and draws a further charge of fluid up into the chamber through the inlet. A range of fluids can be dispensed this way this way including pastes, gels, liquid foams and liquids. In certain applications, the fluid is dispensed in the form of an atomised spray, in which case the outlet will comprise an atomising nozzle. The actuator may be push button or cap, though in some applications the actuator arrangement includes a trigger that can be pulled by a user's fingers.

A large number of commercial products are presented to consumers in a manual pump type dispenser, including, for example, tooth paste, antiperspirant, de-odorant, perfumes, air fresheners, antiseptics, paints, insecticides, polish, hair care products, pharmaceuticals, shaving gels and foams, water and lubricants.

There are a number of drawbacks associated with conventional pump-action dispensers. Firstly, many of the conventional devices tend to be extremely complex in design and typically comprise numerous different component parts. In some designs there are between 6 and 8 individual components, with 8 to 12 individual components being used in dispensers having a trigger actuator. As a consequence, these devices can be costly to manufacture due to the amount of material required to form the individual components and the assembly processes involved. Secondly, many of the conventional devices tend to be bulky (which again increases the raw material costs) and a proportion of this bulk is invariably disposed inside the container to which the device is attached. This creates a drawback in that the nozzle device takes up a proportion of the internal volume of the container, which can be a particular problem in small containers where the available space inside the container is limited. Finally, the size of the pump is also dictated to certain extent by the size of the container to which it is attached. Thus, the size of the pump is usually restricted in small containers, and especially small containers with narrow necks, and this limits the amount of pressure that can be generated by the pump as well as the volume of fluid that can be dispensed, and, for this reason, can be detrimental to the performance of the device.

Conventional pumps tend to use a plunger in a cylinder to drive the liquor out through a precompression valve, a piston and through a swirl chamber and spray orifice. These work well because there is an acceptable amount of dead space in the system and you can deliver an accurate dose at a high pressure. The biggest problem is that they use a lot of components which is expensive in terms of the part costs and assembly. Other cheaper pumps have been developed using fewer components because they make use of flexible parts. The problem with these is that they tend to have a lot of dead space especially in the pump chamber and this makes it difficult to get a consistent dose as some of the liquor and air tends to be left in the pump chamber.

There are some pumps made with flexible inserts but these tend to have a considerable amount of dead space in the system including the pump chamber and the area between it and the spray orifice. This creates a lot of problems when the discharge is only 0.05-0.3 mls and usually around 0.15 mls. The dose tends to be very inaccurate, there is a lot of air in system which wastes energy and adversely affects the spray and the spray is inconsistent.

Another problem with all the small pump designs is that there are losses in the system caused by dead space in the flow path from the pump chamber to the outlet such as in the piston and turning the liquor through 90 degrees and even the swirl chamber itself. All pumps have these losses but they aren't that much of a problem when you are dealing with larger volumes but the losses are important with small volumes. For example, the liquor dispensed at the start and end of the spray has less momentum and this means that larger droplets are produced but where only small volumes are being dispensed the entire volume is less than that at the start or end of the cycle of higher volume dispensers so the problem is more acute.

Dispensers activated by a handle are referred to as triggers and these usually have up to 13 components making them very expensive to tool, make and assemble. They also suffer from all of the problems associated with dispensers as outlined above with even more dead space after the pump chamber.

Many of the products which are supplied in a manual pump action dispenser are high volume products that are very cost sensitive and there is constant pressure on the manufactures of dispensers to reduce manufacturing costs without adversely affecting the performance of the dispenser.

There is a desire for a manually actuated pump dispenser which is:

simpler in design;

utilises fewer components;

is easy to operate and functions effectively;

has little dead space.

In accordance with a first aspect of the invention, there is provided a manually actuated pump type fluid dispenser comprising a casing defining an internal cavity and a pump member at least partly located in the cavity, the pump member having a central core and first and second seal members projecting radially outwardly of the core and spaced in an axial direction of the core for contact with the casing to define a pump chamber within the cavity in an area bounded by the first and second seal members, in which a region of the core between the first and second seal members is resiliently deformable from an initial resiliently biased configuration in which the first and second seal members are axially spaced by a first amount and an axially compressed configuration in which the seal members are spaced by a second amount which is less than the first amount to reduce the volume of the pump chamber.

The region of the core between the first and second seal members may be configured to deform radially outwardly when it is axially compressed so as to reduce the volume of the pump chamber.

The first and second seal members may be configured to engage closely about opposing sides of the resiliently deformable region of the core when it is in the axially compressed configuration.

The resiliently deformable region of the core may substantially fill the entire volume inside the cavity between the first and second seal members when it is axially compressed. The resiliently deformable region of the core may fill 80%, or more preferably 85%, or more preferably again 90%, even more preferably 95%, of the entire volume inside the cavity between the first and second seal members when it is axially compressed.

The region of the core between the first and second seal members may comprise at least one hole, cavity, recess or void. The dispenser may be configured so that the at least one hole, cavity, recess or void is substantially closed when the resiliently deformable region is compressed.

In one embodiment, the resiliently deformable region of the core between the first and second seal members comprises a hole extending through the core, the core having resiliently deformable wall portions surrounding the through hole. In this embodiment, the wall portions of the core surrounding the through hole may curve radially outwardly about the hole. The first and second seal members may have concave surfaces which face inwardly of the chamber for location about the curved wall portions when the resiliently deformable region of the core is axially compressed.

More than one region of the core between the first and second seal members may be axially compressible. Each axially compressible region of the core may comprise a through hole surrounded by resiliently deformable wall portions or other void.

The casing and the pump member may be moveable relative to one another to actuate the dispenser. The casing and the pump member may be moveable relative to one another between a rest position in which the resiliently deformable region of the core between the first and second seal members is in its initial resiliently biased configuration and an actuated position in which the resiliently deformable region of the core between the first and second seal members is axially compressed.

The first seal member may be located at the downstream end of the pump chamber and may be operative as a pre-compression pump chamber release valve, allowing fluid to exit the pump chamber only when the fluid is at or above a pre-determined dispensing pressure.

Where the casing and the pump member are moveable relative to one another between a rest position in which the resiliently deformable region of the core between the first and second seal members is in its initial resiliently biased configuration and an actuated position in which the resiliently deformable region of the core between the first and second seal members is axially compressed, the first seal member may comprise a seal portion for engagement with the casing, and the casing may have formations which are positioned so as to deflect the seal portion and open a flow path from the pump chamber to an outlet orifice of the dispenser when the casing and pump member have moved by a predetermined distance from the rest position towards the actuated position. In this embodiment, the core may comprise a further resiliently deformable region compressible in an axial direction and which is axially spaced from the pump chamber, the further resiliently deformable portion being configured to deform from an initial resilient biased configuration to an axially compressed configuration to enable relative movement between the casing and the pump member from the rest position by the predetermined amount required to open the flow path during actuation of the dispenser in use.

The second seal member may be located at the upstream end of the pump chamber and may be configured to act as an inlet valve member to enable a fluid to be dispensed to be drawn into the pump chamber. The second seal member may comprise two axially spaced flexible seal portions defining an inlet chamber between themselves and the casing, a downstream one of the flexible seal portions being resiliently biased into contact with the casing but moveable in downstream direction away from the casing to allow fluid to flow from the inlet chamber into the pump chamber but not in the reverse direction. The other flexible sealing portion may be resiliently biased into contact with the casing to prevent fluid flowing between itself and the casing from the inlet chamber. One or more fluid passages may be defined within the core to fluidly connect the inlet chamber with a source of fluid to be dispensed.

Part of the core may comprise an inlet portion extending in an upstream direction from the second seal member, the inlet portion having one or more inlet passages defined therein for directing fluid to the pump chamber. The inlet portion may be configured for mounting in passage defined in a body which forms an outlet from a container for holding a fluid (liquid) to be dispensed. The inlet portion may be adapted for mounting directly in an outlet opening in a neck region of a container for a fluid to be dispensed. The inlet portion may include at least one seal member for contact with a surface of body defining the passage or the neck of the container to prevent liquid in the container from leaking out. The seal may be resiliently deformable in a direction away from the surface to allow air to enter the container when the pressure in the container is lower than the ambient air pressure.

The casing may be adapted to be mounted about the neck region of an associated container for movement relative thereto to actuate the dispenser.

The dispenser may have at least one final outlet orifice and an outlet fluid flow path fluidly connecting the pump chamber to the outlet. In one embodiment, the at least one final outlet orifice is provided in a wall of the casing, an outlet end portion of the core being received in a recess in an inner side of the wall adjacent the outlet orifice, at least part of the outlet fluid pathway formed between the surface of the casing defining the recess and the outlet end portion of the pump member. A swirl chamber may be formed between the pump member and casing adjacent the outlet orifice, the swirl chamber being configured to cause fluid flowing into it from the pump chamber to rotate about an axis of the orifice. Features defining the swirl chamber may be integrally formed on the outlet end portion of the core of the pump member and/or on the casing.

The pump member may be a single integral component manufactured from polymeric materials using injection moulding techniques.

The dispenser may comprise a trigger actuator. Alternatively, the casing may be an actuator to which a user can directly apply a force to actuate the dispenser or an alternative actuation arrangement can be used.

The cavity and pump member may be aligned vertically or horizontally when the dispenser is in an upright position. The pump chamber may be located immediately adjacent the outlet to keep the dead space in outlet fluid passageways from the pump chamber to the outlet low.

In an embodiment, the dispenser comprises a collar for mounting about the neck of a container for holding a liquid to be dispensed, the collar having a tube member extending axially from the collar for insertion into the neck of a container to which the collar is mounted, the tube portion having an inner concentric tube portion attached to an end distal from the collar, the dispenser having an actuator including an annular skirt defining the cavity, part of the skirt being located between the tube member and the inner concentric tube portion, part of the pump member comprising the first and second seal members being received within the annular skirt portion to define the pump chamber, an inlet portion of the core being received within the inner concentric tube portion and having one or more fluid passage therein to define an inlet to the pump chamber.

The dispenser may be configured to dispense a liquid as a bolus, or as a spray, or as a foam.

In accordance with a second aspect of the invention, there is provided a manually actuated pump type fluid dispenser comprising a casing defining an internal cavity and an outlet orifice, the dispenser further comprising a pump member at least partly located in the cavity to define a pump chamber, the pump member having an outlet post portion having an axial end which is positioned adjacent a wall portion of the casing in which the outlet orifice is defined, the axial end of the post portion having features defining a swirl chamber between itself and the wall portion.

The post portion may be received in a recess defined by the casing.

The pump member may be a moulded component and the features defining the swirl chamber may be formed integrally with the post portion and/or on the casing.

The outlet post portion may be cylindrical and may be received in a cylindrical recess in the casing, the recess being closed at one end by means of the wall portion containing the outlet orifice, one or more fluid passageways being defined between a side wall region of the recess and a side wall region of the outlet post portion through which fluid (liquid) can pass to reach the outlet orifice from the pump chamber.

In accordance with a third aspect of the invention, there is provided a combination of a manually actuated pump type fluid dispenser in accordance with either one of the first and second aspects of the invention and a container for a fluid to be dispensed, the dispenser being mounted to the container to dispense a fluid from the container.

Several embodiments of the invention will now be described, by way of example only, with reference to the accompanying drawings, in which:

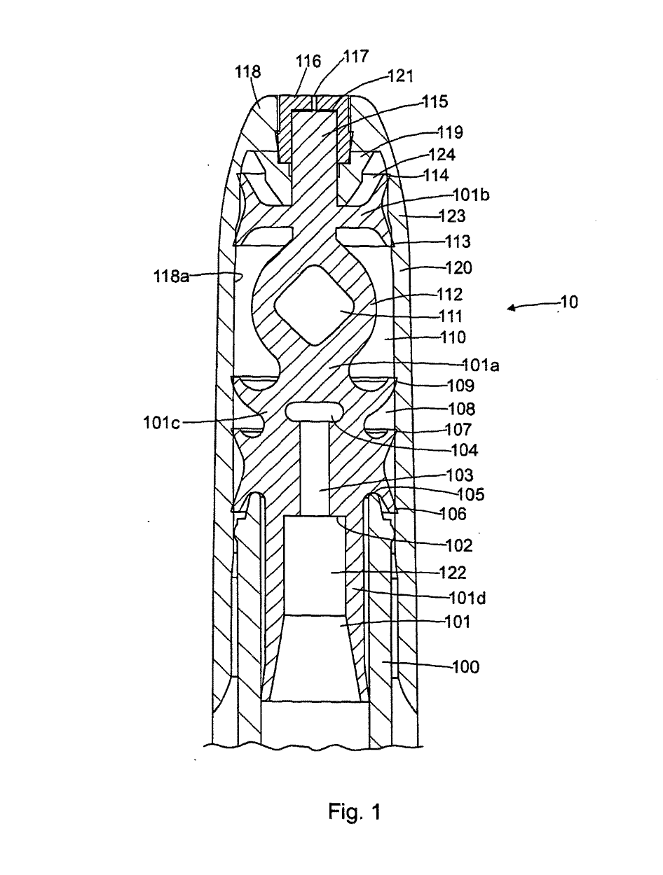

FIG. 1 is a cross-sectional view of basic engine of a dispenser in accordance with the invention, shown prior to actuation;

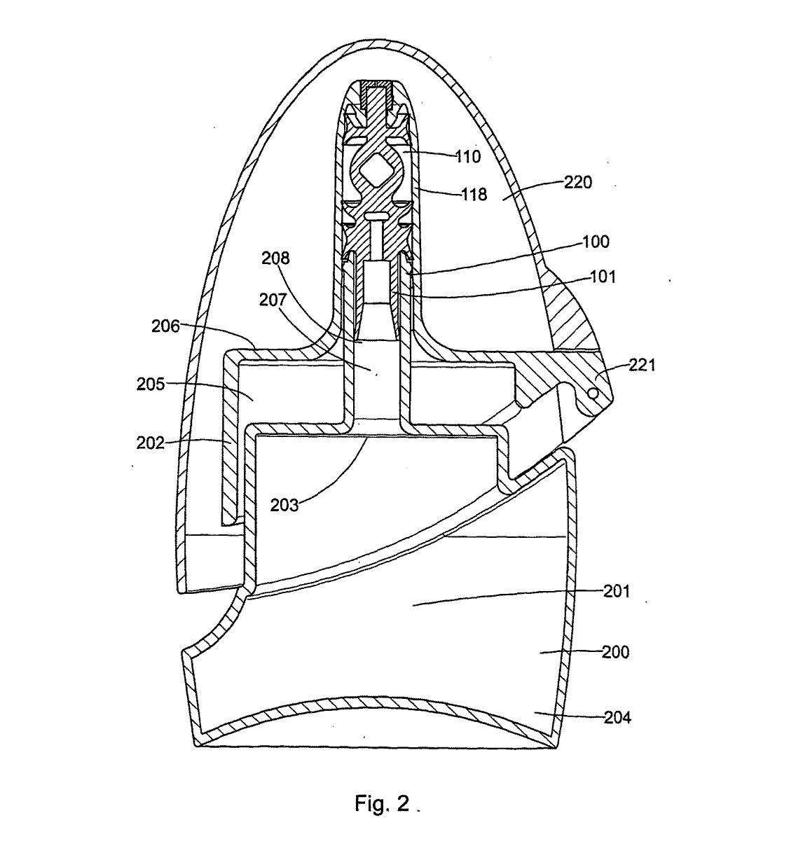

FIG. 2 is a view similar to that of FIG. 1 but showing a complete dispenser and vessel;

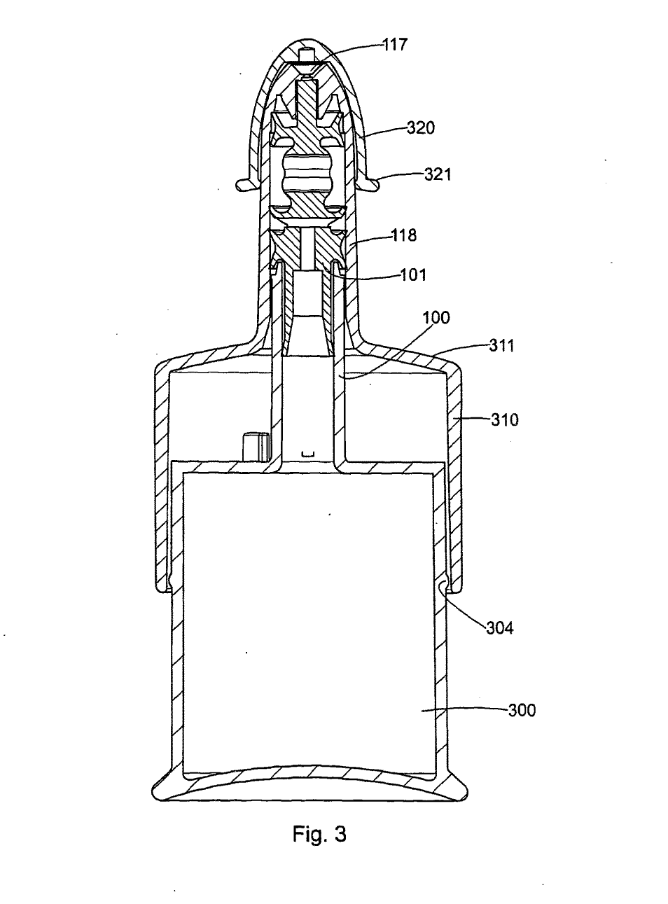

FIG. 3 is a cross sectional view of another embodiment of a dispenser in accordance with the invention;

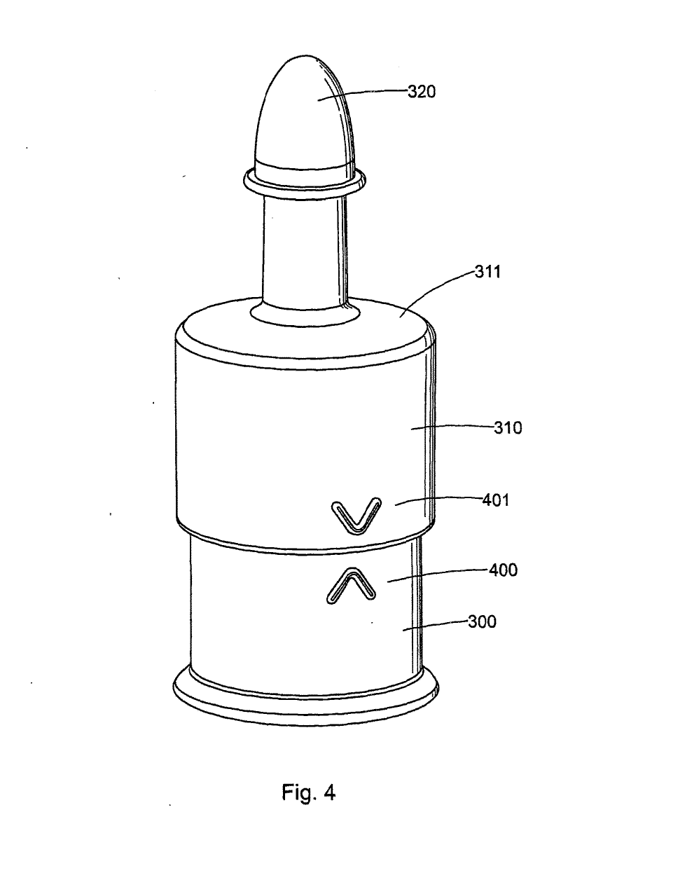

FIG. 4 is a view of the dispenser of FIG. 3;

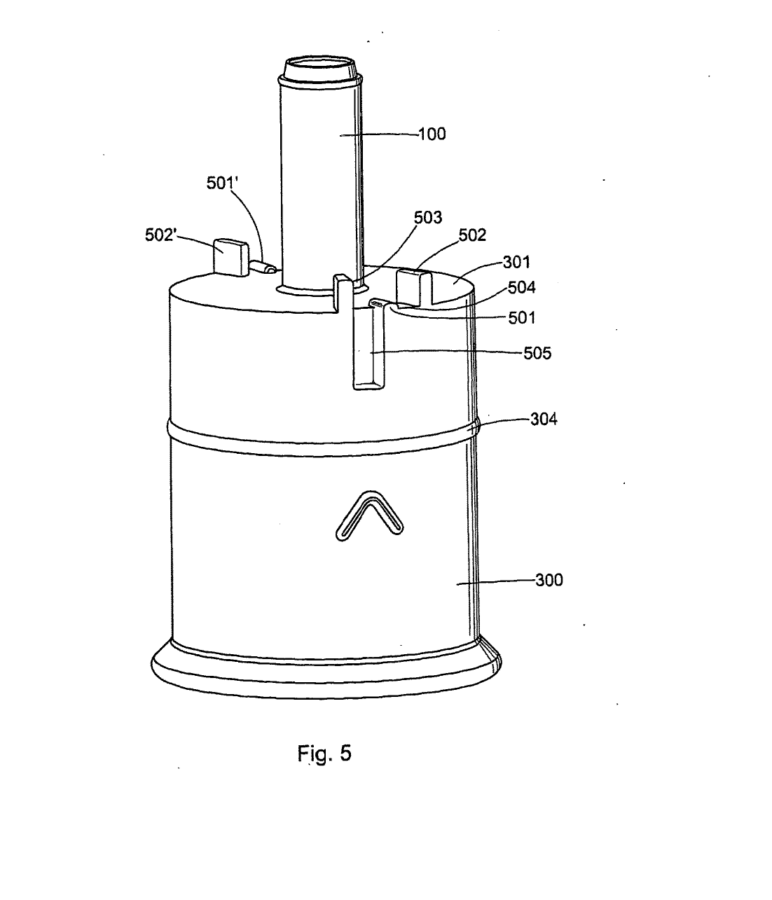

FIG. 5 is a view of part of a vessel forming part of the dispenser of FIG. 4;

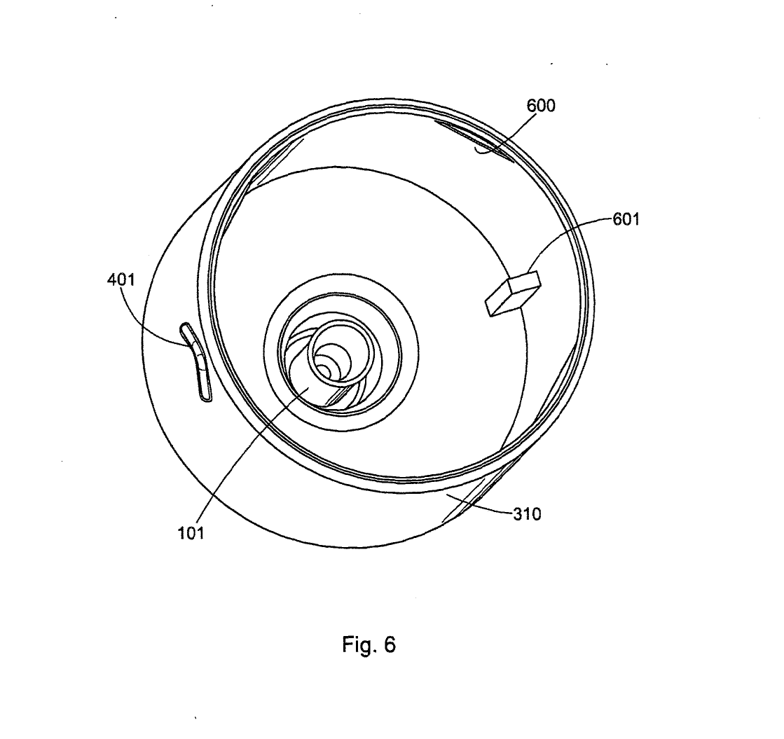

FIG. 6 is a view of the underside of a cap forming part of the dispenser of FIG. 4;

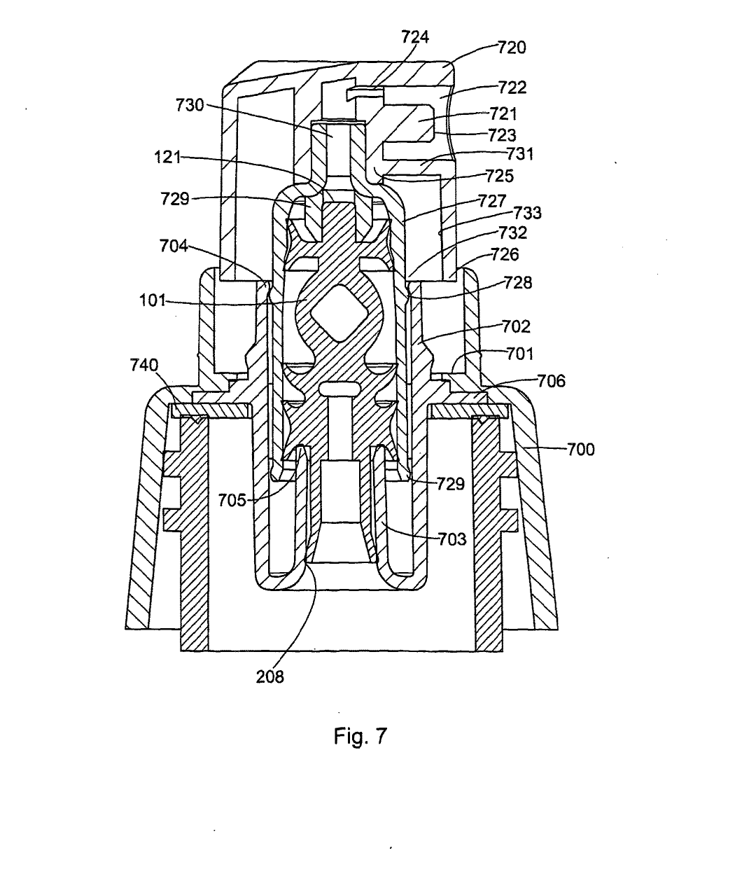

FIG. 7 is a cross sectional view of part of a standard pump modified to take the basic engine shown in FIG. 1;

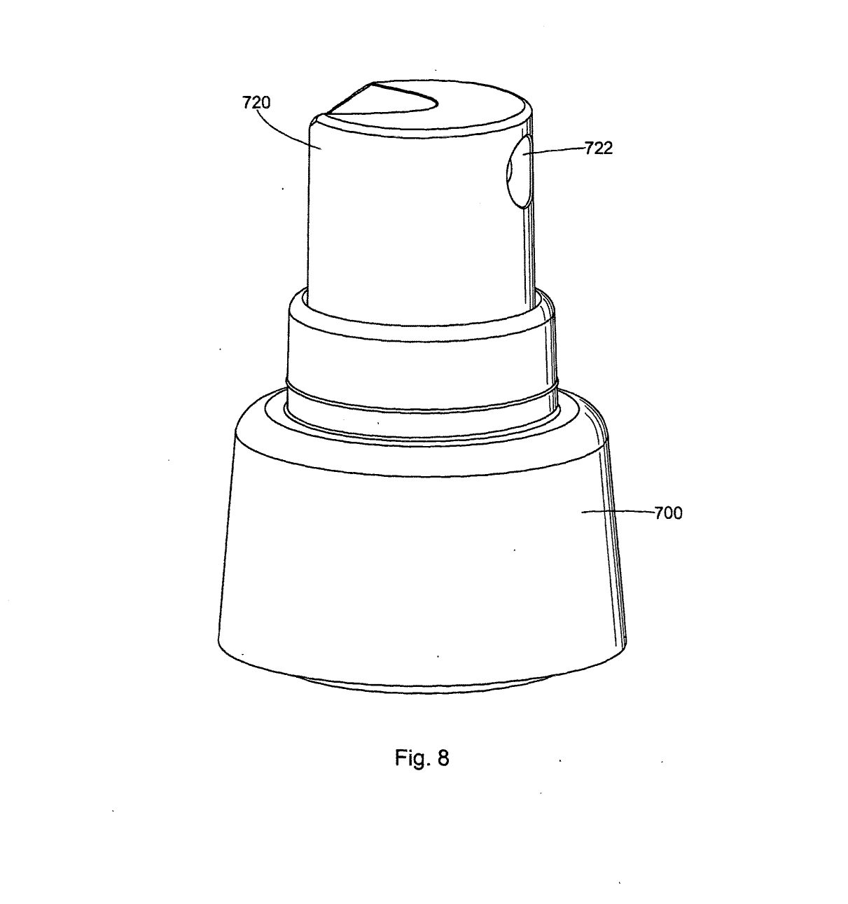

FIG. 8 is a view of the dispenser of FIG. 7;

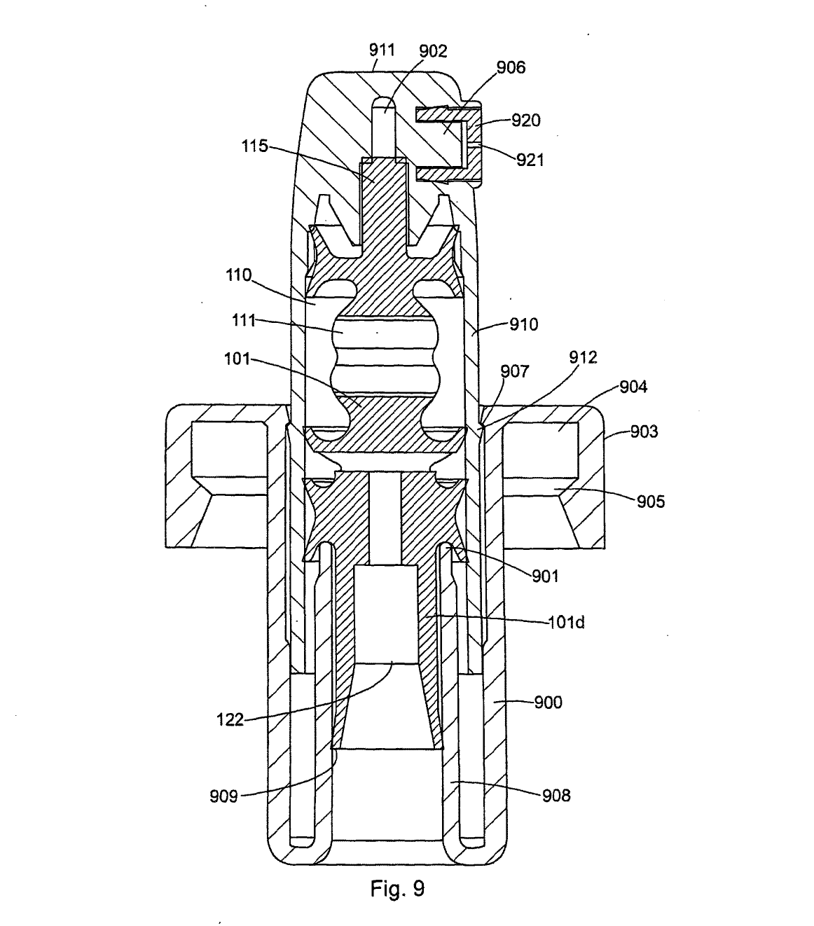

FIG. 9 is a cross sectional view of another dispenser using the basic engine shown in FIG. 1;

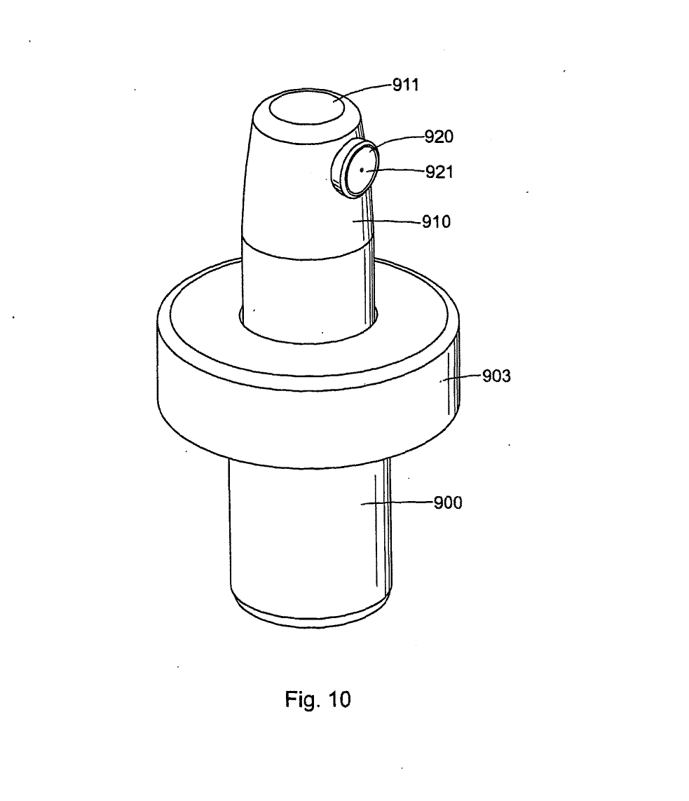

FIG. 10 is a view of the dispenser shown in FIG. 9;

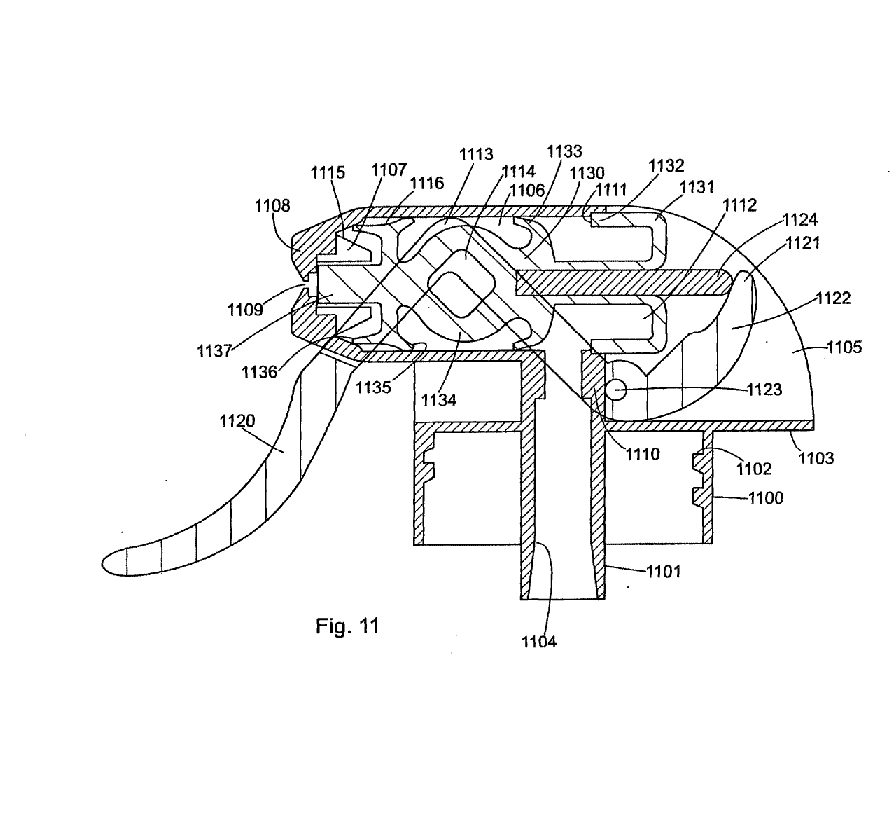

FIG. 11 is a cross sectional view of a trigger pump using a modified version of the basic engine shown in FIG. 1;

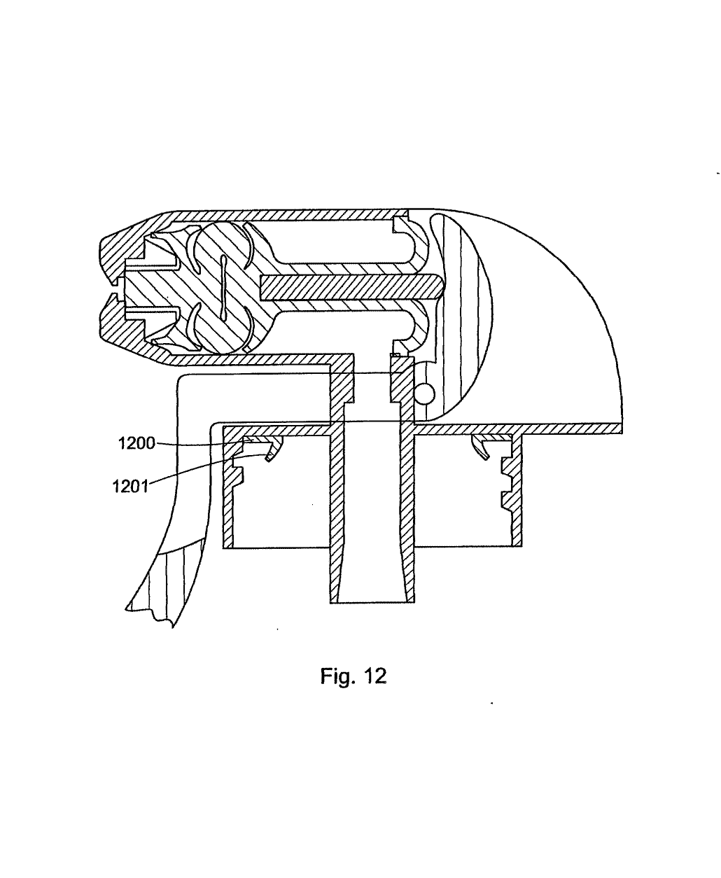

FIG. 12 is a cross sectional view of the trigger pump shown in FIG. 11 using a modified version of the basic engine shown in FIG. 1 with the pump chamber emptied;

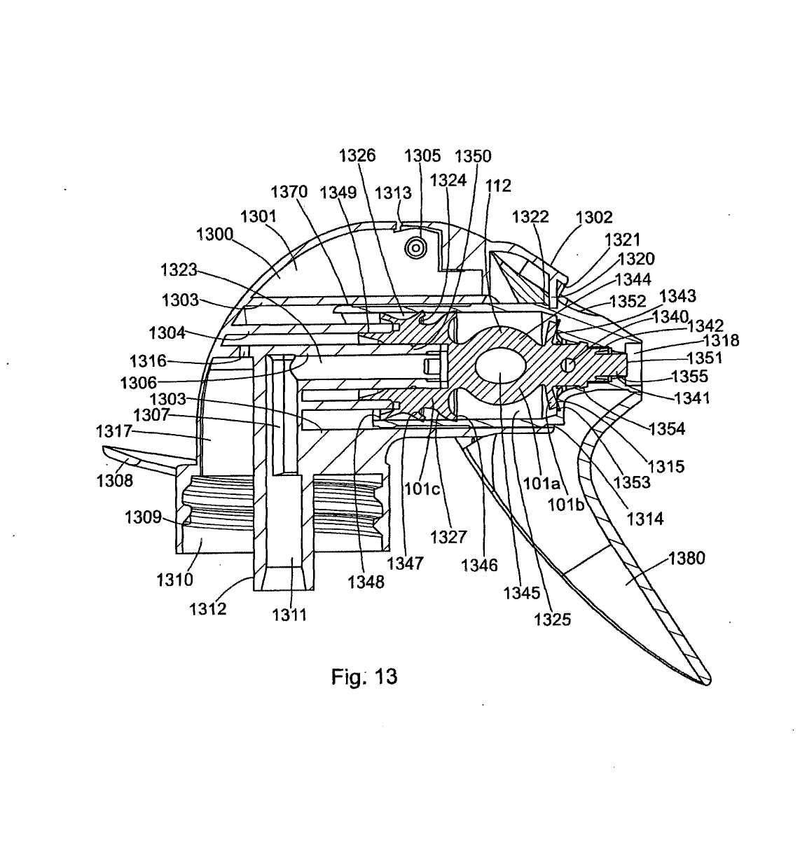

FIG. 13 is a cross sectional view of a trigger pump in accordance with a further embodiment of the invention;

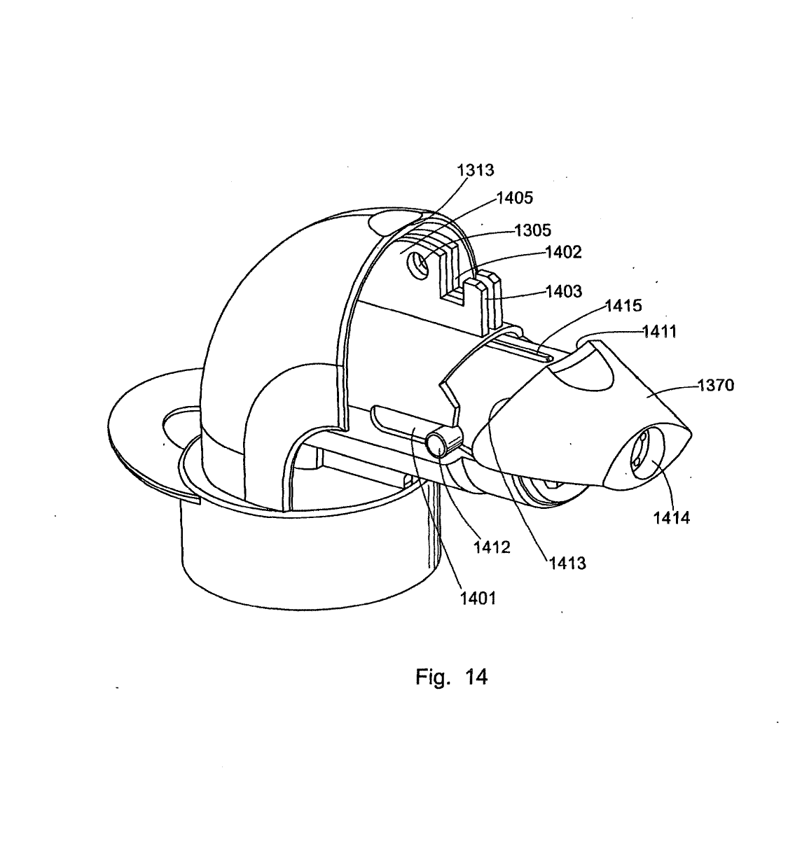

FIG. 14 is a view of the body and nozzle of the trigger pump shown in FIG. 13;

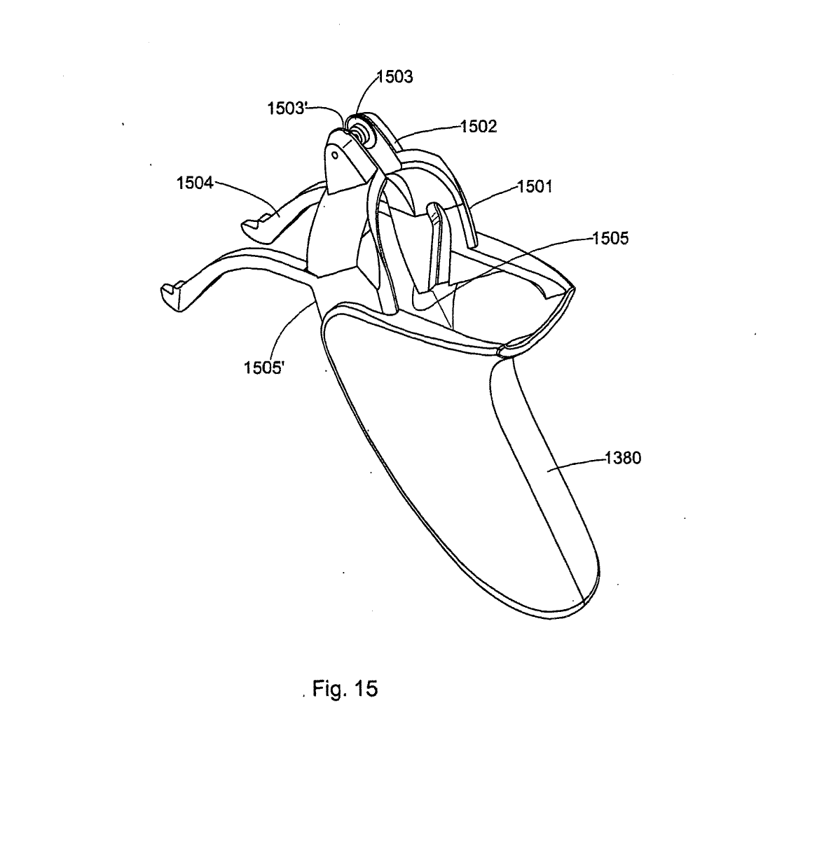

FIG. 15 is a view of the handle of the trigger pump shown in FIG. 13;

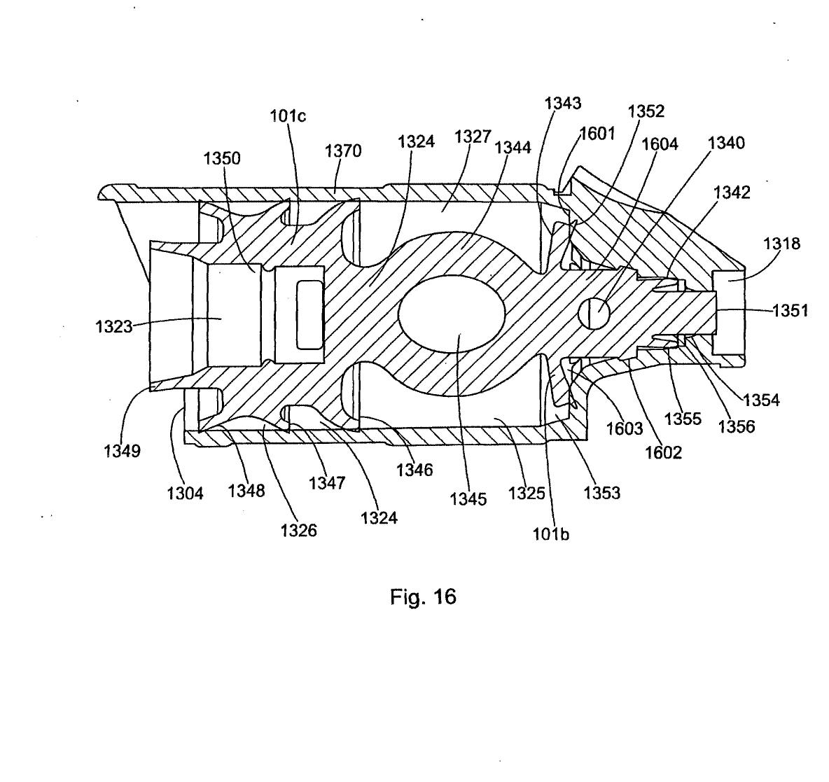

FIG. 16 is a view of the flexible insert and nozzle of the trigger pump shown in FIG. 13;

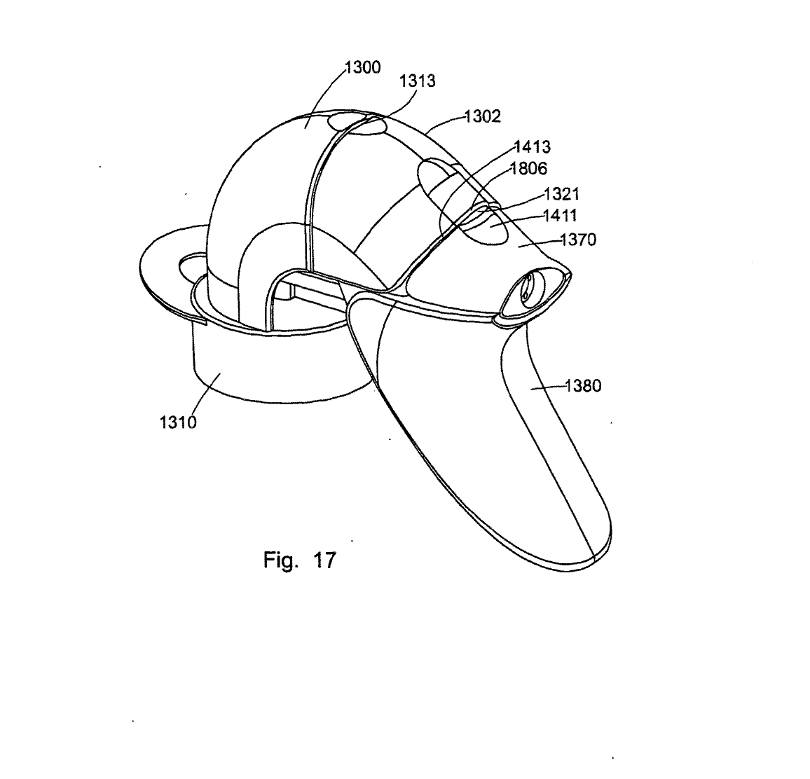

FIG. 17 is an outer view of the trigger pump shown in FIG. 13;

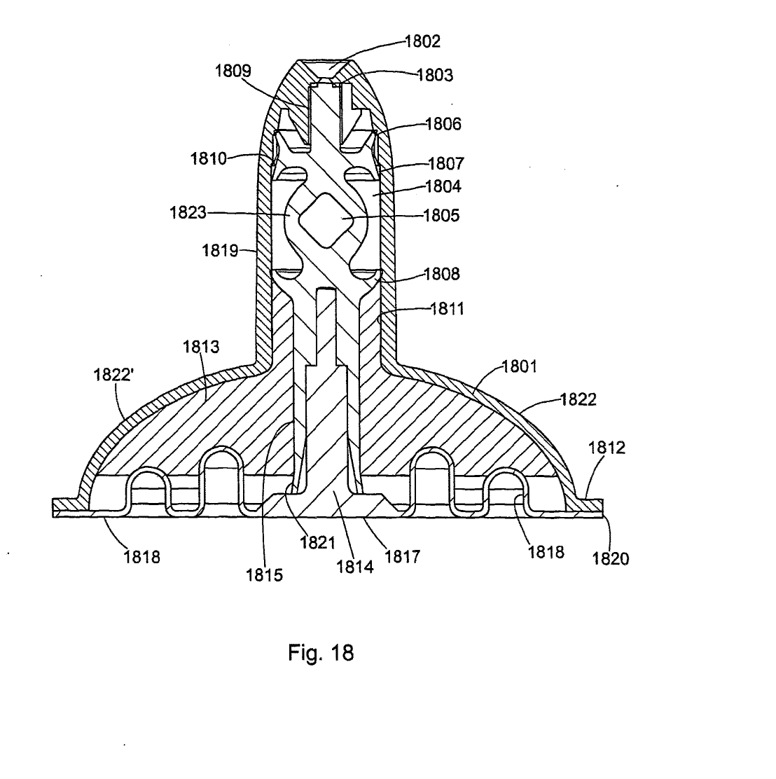

FIG. 18 is a cross sectional view of a pump comprising 2 or 3 parts including the container in accordance with the invention;

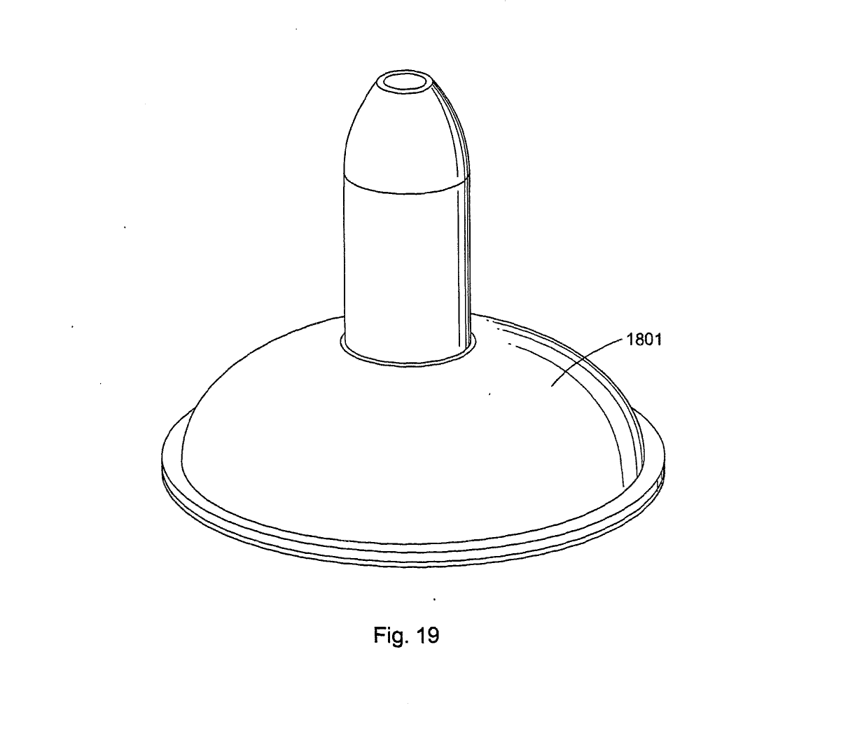

FIG. 19 is an outer view of the pump shown in FIG. 18; and

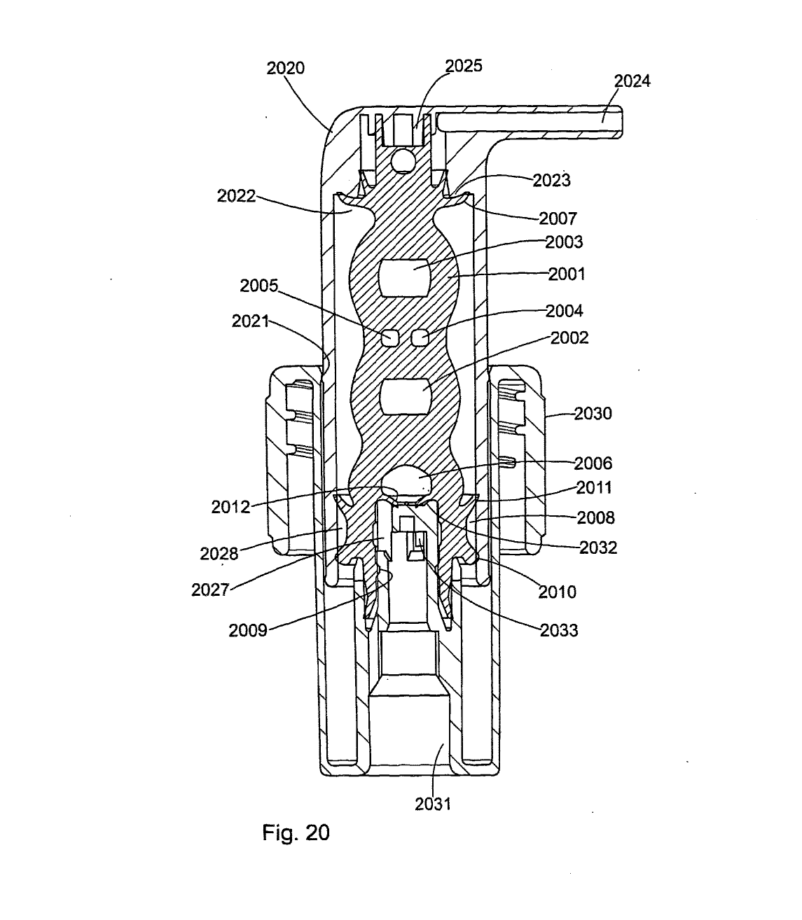

FIG. 20 is a cross sectional view of a further embodiment of a pump in accordance with the invention having an extended insert.

FIGS. 1 and 2 show a first embodiment of a manually actuated pump dispenser 10 in accordance with the invention. The dispenser comprises three component parts: a container 200, an actuating cap 118 and a flexible or resiliently deformable pump member insert 101.

The container 200 has a main body 201 for receiving a fluid to be dispensed and a shaped open neck region 100 which in effect forms a first or base part of the dispenser pump. The cap 118 defines an internal cavity 118a and is mounted around the neck region 100 so as to be moveable relative to the container. The pump member insert 101 is primarily mounted inside the internal cavity of the cap 118 to define a pump chamber 110 and, in this embodiment, all of the valves of the pump dispenser. An inlet portion 101d of the pump member is located within and seals the outlet neck region 100 of the container 200.

The container 200 and cap 118 are preferably formed from a polymeric material such as polyethylene, polythene, polypropylene, polyurethane or the like using injection and/or blow moulding and can be considered to form a casing of the dispenser. The pump member insert 101 may also be formed by injection moulding from a polymeric material. Typically, the pump member insert 101 is made from a material which once moulded remains resiliently flexible such as TPV, TPE, PP, flexible polypropylene, silicon or the like. However, the flexible insert could also be manufactured using bi-injection techniques so as to have an inner structure or framework of a more rigid material onto which the flexible portions are over moulded. This would provide for additional strength but isn't the optimal configuration. The cap 118 and at least the neck 100 of the container are typically formed from a material which is substantially rigid once moulded, or at least substantially rigid when compared with the flexible portions of the pump member 101. The main body 201 of the container may also be substantially rigid after moulding or it may be flexible.

The cap 118 has an annular main body portion which is received over the neck region 100 of the container to define the inner cavity which in the present embodiment is in the form of a generally cylindrical bore. In normal use, downward movement of the cap 118 relative to the neck 100 is limited by contact between the cap shoulder 206 and the container shoulder 205.

In this example as shown in FIG. 2, an over cap or cover 220 is provided to prevent accidental actuation of the device but any locking means such as a twist lock between the cap 118 and the container 200 could be used instead. The cover also protects the spout 120 and nozzle 116 of the cap from dust and other contamination but it could just as easily have been replaced by a small tip cover on the spout instead that could be a separate component or could be connected to the cap by a lanyard. The cover 220 is connected to the cap 118 by a hinge 221 and is shown as a separate component but it could easily be moulded integrally with the cap being connected by a lanyard or an integral hinge.

An outlet orifice 117 is formed at an upper region of the cap 118. In the embodiment as shown in FIGS. 1 and 2, the outlet is in the form of an elongated spout having a round cross section shape with a small “atomizing” nozzle 116 suitable for dispensing a liquid as an atomised spray or fine mist. The atomising nozzle 116 is shown as a separate component but would normally be formed integrally with the spout. A standard swirl chamber can be formed either on the underside of the outer wall of the spout or on the top of the pump member insert 101 at 121. It will be appreciated by those skilled in the art that the outlet 117 can be modified in numerous ways depending on the application and the type fluid to be dispensed. For example, in the present embodiment the outlet 117 is directed generally parallel to the longitudinal axis of the container so as to project upwards when the dispenser is positioned upright. However, the outlet 117 could be arranged to extend horizontally when the dispenser is in an upright position or indeed at any desired angle. Also, instead of producing an atomised spray, it could be configured as a simple dispenser with no swirl chamber to produce a bolus of liquor or paste.

Where the outlet 117 is in the form of a spray nozzle, a swirl chamber or other arrangement may be provided just prior to the final outlet orifice 117 to encourage the fluid to spin about the axis of the orifice in a manner known in the art. This can be any type of swirl or a backspinner.

In the present embodiment, the dispenser would normally be used upright or substantially upright and there would be a diptube (not shown) in a recess 122 in the pump member insert and this would extend to the bottom of the container 200. A lower end of the dip tube has an opening through which fluid can flow into a central bore. The dip tube would normally be a separate component but could be formed integrally as part of the flexible pump member insert 101 itself. The device could be used inverted so that no diptube is necessary.

The pump member 101 is effectively the pump engine and incorporates all of the key elements. The pump member insert 101 has a central core 101a which extends in an axial direction of the spout. Two axially spaced seal members 101b, 101c project radially from the core and contact the inner surface of the cap 118 to define the pump chamber 110 between themselves and the cap within the inner cavity 118a. A region of the core between the first and second seal members 101b, 101c is resiliently deformable (axially compressible) between an initial resiliently biased configuration as shown in FIGS. 1 and 2 in which the first and second seal members are axially spaced by a first amount and an axially compressed configuration (see FIG. 12) in which the seal members are spaced by a second amount which is less than the first amount to reduce the volume of the pump chamber. In the present embodiment, axial compression of the pump member is caused as a result of finger pressure being applied to the cap 118 to move it downwardly (as shown) relative to the container, this is referred to as the down stroke of the pump.

The resiliently deformable region of the core 101a in the present embodiment comprises a hole 111 which extends through the core and which is surrounded on two sides by resiliently deformable wall portions 112. The wall portions 112 curve radially outwardly about the hole, so that they tend to collapse outwardly closing the hole 111 when the core is axially compressed. The first and second seal members 101b, 101c have concave surfaces which face inwardly of the chamber for location about the curved wall portions 112 when the core is compressed. Since the through hole 111 extends through the core, it is in fluid communication with and forms part of the pump chamber 110 so that collapsing the hole also reduces the volume of the pump chamber when the dispenser is actuated. As can be seen in FIG. 12, the pump member is shaped so that when fully axially compressed, the volume of the pump chamber 110 is reduced almost to zero so that there is very little dead space in the pump chamber. The resiliently deformable wall portions 112 of the core are able to reform to their initial resiliently biased configuration when the actuation force is removed from the cap 118. This moves the cap 118 away from the container to reform the pump chamber 110. Thus the resiliently deformable region of the core 112 also forms a return spring for the dispenser.

The resiliently deformable region of the core is shaped and configured to deform radially outwardly when it is axially compressed so as to reduce the volume of the pump chamber. As shown in FIG. 12, the resiliently deformable region substantially fills the entire volume inside the cavity between the first and second seal members when it is fully axially compressed, with the first and second seal members engaging closely about opposing sides of the bulging core region. The pump member is preferably configured so that the compressed core region fills at least 80%, or more preferably at least 85%, or more preferable again at least 90%, even more preferable at least 95%, of the entire volume inside the cavity between the first and second seal members when it is fully axially compressed. In the present embodiment, the resiliently deformable region of the core includes a through hole 11 which is substantially closed when the core is compressed but it will be appreciated that other arrangements to allow for axial compression of the core are possible. Thus the resiliently deformable region of the core may be provided with one or more cavity, recess or other void, such as an indent or wedge shaped recess in a side of the core, which can be collapsed to allow the core to be compressed axially.

The first seal member 101b includes two flexible seal portions 113 and 114 which close the downstream side of the pump chamber 110 whilst the second seal member 101c includes three flexible seal portions 106, 107, 109 which close the upstream side of the pump chamber. These seal portions butt up against the inner wall of the spout 120 to form seals and a number also form valves for controlling the flow of fluid into and out of the pump chamber 110.

Two of the upstream seal portions 107, 109 are axially spaced apart and define an inlet chamber 108 between themselves and the wall of the cap 118. The inlet chamber is 108 is fluidly connected with an inner fluid chamber 104 formed inside the core which in turn is fluidly connected with an axial inlet fluid passage 103 in the core and a larger diameter inlet passage 122 formed in an inlet portion 101d of the core. The inlet portion extends in an upstream direction beyond the second seal member 101c and fixes into the neck 100 of the container. The inlet portion 101d forms a seal at 208 inside the neck region which prevents liquor from escaping from the container when inverted. As liquor is dispensed, a vacuum is created inside the container and this causes the seal 208 to distort inwards which in turn allows air to be drawn past it and into the container equalising the pressure and allowing the seal to return to its original shape. Only a very small gap is created and this prevents the liquor from escaping. The air is drawn from between the cap and container and then down inside the neck of the container between it and the flexible insert.

The seal portion 109 is located at the downstream side of the inlet chamber 108 and is in the form of an annular sealing skirt which faces in a downstream direction. The seal portion 109 forms a valve which deforms inwardly in a downstream direction parting from the wall of the spout 120 to allow liquor from the inlet chamber 108 to pass into the pump chamber 110 when the pressure in the pump chamber 110 is lower than that in the inlet chamber 108 as the pump recovers after each actuation. The seal portion 109 prevents liquor escaping upstream from the pump chamber 110 into the inlet chamber 108 when the pump is actuated and the pressure in the pump chamber 110 is higher than that in the inlet chamber 108. Accordingly, when the dispenser is actuated the seal 109 is pressed outwardly in an upstream direction (downward as shown) by the liquid in the pump chamber 110 thus increasing the seal on the spout wall. The seal portion 107 on the upstream side of the inlet chamber 108 is also in the form of an annular sealing skirt facing downstream and this prevents liquor from the input chamber 108 escaping between the cap and flexible pump member insert, particularly when the pressure in the inlet chamber 108 is higher than the ambient air pressure. The final seal portion 106 on the second seal member 101c, is located upstream from the inlet chamber 108 and is in the form of an annular sealing skirt which faces upstream. Seal portion 106 is operative to prevent air from entering the inlet chamber 108 when the pressure in the inlet chamber is lower than the ambient air pressure.

The seal portions 113, 114 on the first seal member 101b include a first annular sealing skirt 113 adjacent the pump chamber which faces upstream to prevent fluid from exiting the pump chamber 110. This is followed by the seal portion 114 which is in the form of an annular sealing skirt which faces downstream. The outer sealing skirt 114 is designed to prevent air getting back from the outlet nozzle 117 to the pump chamber 110 when the pump recovers after each actuation. The seal portions 113, 114 also form part of a pump chamber outlet valve which allows fluid in the pump chamber to pass to the outlet nozzle 117.

Seal portions 113, 114 form a pre-compression valve because they have been designed to allow the liquor through from the pump chamber to the outlet but only when it has reached a set pressure level, usually somewhere between 0.5-5 bars with 3-4 bars being typical. The two valves 113 and 114 are fixed on the outside of a cylindrical plate 123 forming part of the seal member 101b that extends outwards from the core 101a of the flexible pump member insert 101. Part of the extended plate 123 close to the core 101a butts up against a raised annular section 119 of the spout 120 when the pump is actuated. This causes the second seal member 101b to deform, breaking the seal between the seal portion 113 and the wall of the spout to open a flow path from the pump chamber 110 to the outlet orifice 117. The shape of the raised section 119 determines how much butts up against the plate portion 123 and so determines the amount of force needed to deform the seal member and to open the valve.

When the dispenser is initially actuated, the resiliently deformable region of the core between the first and second seam members is unable to axially compress as the pump chamber 110 is full of liquid and the inlet and outlet valves 109, 119 are closed. However, the pressure of the liquid in the pump chamber causes the plate region 123 of the first seal member 101b to bend about the raised annular section 119. This tries to draw the seal portion 113 away from the surface of the casing but the seal portion 113 is biased outwardly in a downstream direction against its internal resilience by the pressure of the liquid in the chamber and so maintains sealing contact with the casing. Eventually the distortion of the plate 123 becomes sufficient that the seal portion 113 can no longer maintains sealing contact with the casing and liquid is able to flow past seal portion and the valve opens. When the valve opens and the pressure differential across the seal portion 113 is removed, the resilience of the material causes the seal portion 113 to reform in a direction away from the surface of the spout so that the flow path is opened quickly and fully. To ensure the valve opens properly small ramps are provided on the inner surface the spout between seal portions 113 and 114 so that as seal portion 113 is distorted by the liquor pressure in the pump chamber and is pushed downstream, it rides up the ramps pushing it away from the spout wall letting the liquor pass to the outlet nozzle. Instead of ramps there could be one or more indents so once the seal portion 113 is pushed towards the indents it can no longer form a seal and the liquor can escape. Once the liquid is able to pass the seal portion 113, it is easily able to deflect the downstream facing seal portion 114 inwardly so that the fluid can pass along passageways to the outlet orifice 117. Any type of pre-compression valve could be used but this integral valve arrangement is preferable.

This valve is a version of our pre-compression valve which is described and claimed in International patent application No. PCT/GB2010/050780 and is a great improvement over previously known pre-compression valves. The contents of PCT/GB2010/050780 are incorporated by reference. Conventional pre-compression valves will open a minimum amount to let liquor pass but with this valve arrangement the first seal member 101b is progressively pushed downstream as the pressure in the pump chamber 110 increases and is bent inwards at 124 around the feature 119 but the sealing skirt 113 is forced outwards by the fluid pressure in the pump chamber maintaining the seal against the spout wall. Eventually, the sealing skirt 113 meets the ramps or groves and this allows the liquor to escape reducing the pressure in the pump chamber 110 and allowing the sealing skirt 113 to reform to its original shape taking it further away from the wall increasing the gap for the liquor to escape. This means there are few losses to friction at this point. It would work without the ramps or grooves but this is even more efficient.

Once past the seal portion valve 113 the liquor easily deforms the seal portion valve 114 downstream as it has no strength in that direction and then the liquor goes between the raised section 119 and an outlet post portion 115 of the core through one or more grooves or through an annular gap and then onto a swirl or backspinner at 121 and through the orifice 117 where it is emitted as an atomised spray. The swirl is formed at the downstream end of the flexible pump member insert 101 between it and the end of the spout 120 at 121 either on the output post portion 115 or on the spout. This version shows a swirl insert 116 which the outlet post portion 115 sits inside and it also butts up against the upstream wall of the swirl insert creating a swirl chamber into which the liquor flows and which then causes the liquor to spin before exiting through the spray orifice 117 as an atomised spray. A small gap, gaps or grooves in either the swirl insert or the post allow the liquor to flow between them. Normally though, there would be no separate insert and the outlet post portion 115 would locate in a recess formed directly in the in spout and the swirl would be made either on the end of the flexible post 115 or more commonly on the inside face of the spout 120 saving a component. Where the dispenser is not required to form an atomised spray, the swirl chamber or backspinner can be omitted.

The sequence of working of the device is as follows. The user press down on the shoulder of the cap at 106 and this pushes the cap towards the container and causes the central core 101a of flexible pump member insert to deform at the axially compressible spring portion 112. As it does so, the first seal member 101b is deformed downstream and the sealing skirt 113 is also pushed downstream and onto the ramps lifting it away from the spout wall and allowing the fluid in the pump chamber to exit the chamber. The sealing skirt 114 is then deformed downstream and away from the spout wall by the fluid allowing the fluid to flow through an outlet fluid passageway to the swirl chamber at 121 and then the final orifice 117. As the cap moves towards the container so the first and second seal members 101b, 101c move closer together and the axially compressible part of the core 112 flattens taking up more and more of the space in the pump chamber 110 and forcing out any fluid until there is none left inside the chamber and the space in the chamber is minimal. Once all of the fluid has been expelled from the pump chamber 110, the seal portion valves 113 and 114 reform and seal against the spout wall. Some of the fluid will remain around the outlet post 115 and upstream of the final seal portion valve 114 but this is minimal because the dead space in that area has been minimised. Next time the pump is activated this liquor will be expelled at the start of the spray and will be replaced at the end of it. The volume of it is very small and typically around 5-10 micro litres. When the cap is depressed and the core 112 compresses, liquor exerts pressure on the pump chamber input valve, seal member 109 and this is pushed harder against the spout wall 120 preventing the liquor getting back to the input chamber 108.

Once the fingers release the pressure on the cap, the resiliently deformable part of the core 112 will reform in the manner of a spring and will move the cap 118 away from the container until it reaches its original position. As it does so, the volume in the pump chamber 110 is increased which creates a vacuum in the pump chamber and this causes the seal portion 109 to distort in a downstream direction to allow fluid to be drawn into the pump chamber from the input chamber 108 via a diptube or through the channel 122. This continues until the pump chamber has refilled, at which point the seal member valve 109 reforms sealing against the tube wall. The vacuum in the pump chamber will also try to pull air from outside of the bottle between the spout and the bottle but it cannot as seal 106 is sucked harder against the spout wall 120 sealing it even more. Liquor will also try to get out of the bottle between the flexible insert 101 and the container neck 100 but is prevented from doing so by the upstream end of the flexible insert which forms a valve at 208 between it and the neck of the container 200. The liquor pushes against it causing the flexible part to seal ever tighter against the neck. But air must be drawn into the container to replace the used liquor and this is drawn between the cap and the outside of the neck past 105 where there is a groove or gap and down to the valve 208. The valve 208 easily deforms in this direction allowing a tiny gap that is large enough for the air to pass but too small for the liquor to exit.

Dispensers in accordance with the invention usually deliver a fixed dose and this varies according to the requirement. The dose in this case is determined by the size of the chamber 110. So to vary the dose we simply need to vary the size of the chamber and this can be done by varying the chamber length or diameter or both. Varying the diameter means varying the internal diameter of the spout accordingly. Another way would be to vary the axial amount of the chamber that is depressed and this can be done by altering the distance that the cap can move relative to the container. This is a fairly simple job and can be done with protrusions on the inside or outside of the cap or the container.

Prior art dispensers have used a flexible insert but in most prior art arrangements the liquor is contained inside a flexible tube or part tube or bellows using the actuator as a lid or base. These side walls take up space and they have to be deformed which then takes up more space and valves have to be constructed inside the tubes which is difficult when they are small. In the dispenser according to the invention, the pump member insert has no side walls or part side walls and has a top and base which also form the inlet and outlet valves and the actuator cap makes up the side walls of the chamber. The central core part 101a of the flexible pump member insert forms the return spring for the dispenser and the valves are integrally formed from the flexible insert making contact with the actuator cap. This way, minimum space is used and dead space is also minimised ensuring a more accurate dose. Pump dispensers in accordance with the invention are particularly well adapted for use as small pumps with discharges of up to 0.5 mls and particularly up to 0.3 mls or thereabouts although they could be used on larger pumps.

FIG. 2 shows a complete pump, bottle and cap of the sort that would be used in the pharmaceutical industry for applications such as a nasal spray and includes the parts shown in FIG. 1. The cap 118 sits on a shaped bottle 200 that is normally a blow moulding. It has a long cylindrical neck 100 in which the flexible pump member insert 101 sits and on which the cap 118 sits. If used in an upright position then there would be a diptube (not shown) inside the bottle that fixes into bore 122 in the flexible input portion 101d. The shoulder of the cap 118 is depressed in use until it touches the bottle at the shoulder 205 or more normally until the pump chamber is empty when it would still be above the shoulder. Since the spout 120 is often pushed into a nose or ear it normally has a cover and in this case the cover is 220 which hinges over the cap at hinge point 221 until it snaps into position over the cap and around much of the bottle. This also serves as a lock for the pump as the cover cannot be further depressed once in position and therefore the pump cannot be activated.

The basic dispenser pump arrangement as described above can be modified for use with a range of different types of covers and vessels including any of the versions shown in the accompanying drawings. In FIGS. 3-6 there is shown a more conventional cylindrical bottle 300 but with the same narrow elongated tubular neck 100 and the flexible pump member insert and spout are the essentially the same as in the embodiment shown in FIGS. 1 and 2 and described above. The container bottle has a shoulder 301 and a raised rim 304 both running around the side of the bottle. There are two pairs of upstands 502 and 502′ and 503 and 503′ on opposite sides of the shoulder 301 which act as a locking feature when combined with the internal stubs 601 and 601′ on the inside underside of the cap 310 shown in FIG. 6. When the device is in the open or active position the stubs 601 and 601′ inside the cap are above and lined up with the grooves 505 and 505′ and touching the sides of upstands 503 and 503′ on the shoulder 301 of the container 300. When the cap is depressed the stubs go down the grooves. To lock the device you simply rotate the cap anticlockwise so the stubs 601 and 601′ inside the cap contact the upstands 502 and 502′ on the shoulder of the cap so that they can no longer enter the slots 505. There are two other smaller corresponding upstands 501 and 501′ on the shoulder of the cap 300 and the stubs 502 and 502′ have to be forced over these to lock and unlock the device so the stubs are held between them and the upstands 502 and 502′ or the upstands 503, 503′ in the locked and unlocked positions. The arrow markings 400 and 401 in FIG. 4 on the outside of the container and cap respectively show when the device is in the locked position and rotating the cap opens it. Of course, any suitable lock could be used instead and this is simply one example.

The raised rim 304 on the outside of the container 300 is used in conjunction with 4 raised sections 600 shown in FIG. 6 to prevent the cap 310 coming away from the container. The cap is forced onto the vessel by pushing the sections 600 over the rim 304 and the cap bows out in these areas to allow the sections to pass over the rim. The 4 sections then butt up against the underside of the rim holding the two part together so the cap can go further down onto the vessel but not back up. This is a standard way of fixing two bodies together.

The spout 100 is protected at the end by a simple tubular cover 320 that is pushed onto the spout and held in place by friction to keep the end of the spout clean and to seal off the orifice 117.

This device would normally have a diptube but the container 300 could be deformable instead or the base could be a follower instead that moves upwards as the liquor is emptied. For small bottles the diptube could be made out of the flexible insert itself with the base of it simply being extended downwards in a tubular shape but still keeping the bottom valve. It could also be converted into a tilt device as per our patent PCT/GB03/003852 “Improvements in or relating to dip tubes” by sealing the bottom of the extended tube and putting a small hole or slit in it so the tube refills slowly after use when the vessel is stood vertical and the tube is immersed in the liquor so little air is drawn up into the pump chamber ensuring a more consistent dose.

With a commonly used spray pumps such as perfume or hairspray it isn't really desirable to spray vertically as in the embodiments shown in FIGS. 1-6 as it is quite awkward so you want to push downwards on the top of the cap and spray horizontally. The same basic arrangement using a flexible pump member insert 101 could be mounted vertically in a cavity formed in part of the dispenser casing to which an outer dispenser cap or actuator 720 having a horizontally aligned outlet orifice is mounted. An example of this is shown in FIGS. 7 and 8. Dispensers of this nature normally spray horizontally usually through a spray insert like 921 in FIGS. 9 and 10 mounted on a fixed post 721 in the actuator 720 at 722 with the swirl or backspinner being made on the downstream end of the post at 723 or on the upstream face of the spray insert.

One of the problems with making pumps is the enormous capital required for the tooling and assembly equipment yet the margins on the devices are really low with prices falling year on year. The fact that we use fewer parts obviously brings these costs down but it is also very advantageous if we can make them in such a way that most of the device can be made by converting existing tools and using the same assembly equipment. This design is an example of just that. We take a standard actuator and add an internal tube 727 onto the underside of it and this is designed to take the flexible pump member 101 previously shown. This can be done by modifying the actuator tool and the spray insert is identical to those already available. At the top of the new tube we add the conical upstand 729 which forms part of the pre-compression valve in place of the raised section 119 in the FIG. 1 embodiment which assists in making the pre-compression valve work as described before. The post 121 is part of the core of the pump member and locates in the outlet passage to fill some of the dead space found in standard actuators and it could be made longer than shown to fill out even more of it. The liquor passes between it and the tubular walls of the upstand 729 through grooves or an annular gap as before. Different tube diameters and lengths of 727 are used in conjunction with different sized flexible inserts 101 to produce a range of pump discharge volumes.

The next step is to modify the collar 700 of standard pumps. In order to make pumps fit a range of different bottle neck sizes, shapes and threads a range of collars 700 are made with the appropriate thread or fixing and diameter. These have differing hole sizes with ledges 701 inside so that different sized pumps can be used with them but the actuators fit all of them. This way the various pumps can be fitted with various collars and this considerably reduces the number of pumps required. So we alter the collar tools so they include the tubular section 704 which the actuator tube 727 goes into and the connected lower inner tube 703 that goes inside the actuator tube 727 and that the flexible insert 101 sits astride and inside. For bottle necks that aren't very well made you often use a small flexible sealing pad or ring 740 that goes around the collar shoulder edge and sits on top of the bottle neck. This could be used here or a small ring could be over moulded onto the collar. An alternative method would be to leave the threaded collar 700 as it is and to make the features added to the collar 704 as a separate part that also acts as the sealing pad 740. This could be a bi-injection moulding to get the seal required and to give the strength needed for the inner tubes. This arrangement reduces the part count of a standard pump by 7 and considerably reduces the assembly costs yet the pump looks and feels the same and performs better.

The device works in a very similar way to the previous embodiments as described above. The actuator 720 is pressed down by a finger onto the gap between it and the collar 700 until it nearly meets the ledge 701 of the collar 700. As it moves downwards the flexible pump member insert 101 is compressed to actuate the dispenser.

In earlier International patent applications WO 2009/130461 and WO 2009/130462, the contents of which are incorporated by reference, we have described how to alter a standard pump dispenser so it also delivers air at the same time as the liquor and this is by creating a flexible plunger in the collar that seals against the inside of the outer wall of the actuator. A similar arrangement can be incorporated into the present dispenser in FIG. 7 by adding a similar flexible plunger on top of the new tube 704 at 732 made on either the collar or usually as a separate part that seals between it and the actuator tube 727 and the actuator outer wall at 733. The actuator would then be altered as in our previous patent applications to achieve the various possible types including usually having an air outlet at 731 in the actuator outlet. The air is drawn back into the actuator on the down stroke through the new plunger seal as in the original patent. For dispensing a foam, the disposer may have a spout on the outlet and a filter/mesh arrangement inside with the air going directly into the spout as in the previous patent at 731.

Many pumps that spray horizontally are pushed over a plain bottle neck and held in place by friction and perfume pumps are an excellent example of this. They tend to deliver a very low discharge of around 0.05-0.1 mls so they are very small but they still have a similar number of components. We illustrate in FIGS. 9 and 10 how we can use a similar pump arrangement to that described in relation to previous embodiments in these applications. A threaded collar for attachment to the neck region of a bottle or container has an inner tube 900 that goes inside the bottle or vessel. The inner tube 900 is connected to another concentric tube 908 portion inside which forms an inlet to the dispenser pump. An actuator 910 is mounted inside the inner tube and has a skirt portion which locates between the inner tube 900 and the concentric tube portion 908. The actuator defines an internal cavity in which part of the flexible pump member insert 101 locates to define a pump chamber 110. The inlet portion 101d of the pump member fits inside the concentric tube 908 to define an inlet and to seal the container. The actuator 910 is a cylindrical tube closed at the top where the finger goes and is open at the base. It will usually have an integral post 906 on which the spray insert 920 is fixed much like in FIG. 7 and a swirl chamber will be defined either on the post 906 or on the upstream face of the insert 920. Alternatively, the dispenser could simply be used to discharge a bolus of liquor or paste in which case the outlet hole without the post would suffice or a spout would be added.

The flexible pump member 101 can be the same design as in FIG. 7 when the spray insert is added or when it is used as a dispenser. The actuator 910 is held in the collar by a raised annular inner ring 907 on the collar and a comparable raised annular ring 912 on the outside of the actuator 910 and the actuator is forced over the ring 907 so it cannot easily get out. A twist lock could be made so the actuator is locked until it is twisted around through say 30 degrees when raised features on the outside of the actuator line up with vertical slots on the inside of the outer tube of the collar so the actuator can be pushed downwards. Otherwise it works in the same way as the device in FIG. 7 and the previous embodiments. As with the embodiment in FIG. 7, the dead space after the outlet post portion 115 of the flexible pump member at 902 could be minimised further or taken away all together by making the post with a narrower extension that fit into the chamber 902 or by reducing the chamber itself.

The previous embodiments have focussed on rigid vessels but these pumps could also be used with flexible or deformable vessels including sachets, bags, blister packs, capsules etc. They could produce a spray, bolus or foam. An outlet tube from the container would be equivalent to the tube 900 in the embodiment shown in FIG. 9 and it would normally be a rigid part fixed into the bag and the flexible pump member insert 101 would sit in and astride it as before and there would be an actuator 910 or cap as before. Any lock design such as a twist lock could be used or even an overlap. Since it would be collapsible there would be no need for an air valve like at 909 to allow air to get back into the vessel to replace the used liquor. Of course, this is just one possible example of how the device could look on the flexible container.

All the configurations shown and especially FIGS. 3, 7, 8, 9 and 10 could easily be adapted to be actuated by means of a trigger where a trigger handle acts upon the cap or actuator holding the flexible insert and is hinged to the collar so as the handle is pulled inwards the actuator is pulled downwards. Another arrangement for producing a dispenser in accordance with the invention so as to incorporate a trigger actuator is shown in FIGS. 11 and 12. In this embodiment, a modified flexible pump member insert 1130 is mounted horizontally with a trigger handle acting directly upon it. The trigger handle is hinged at 1123 on an integral pin 1110 on the body 1100 of the dispenser so that so pulling down and in on the handle 1120 causes a prodder, either separate like 1124 or integral with the handle 1120, to be moved by the end 1121 of the handle as it rotates and to push part of the flexible insert 1130 downstream inside the tube 1106 of the body 1100 towards the outlet 1109. The handle is fixed to the body 1110 by the pin 1110 and most of the handle and the tube 1106 are hidden by a cover or shroud 1105 which is also part of the body 1100 but which could be separate. Initially, the precompression valve 1135 on the flexible insert 1130 will deform and move downstream and outwards until the pressure is too great and it will give way and come away from the wall of the tube 1106 of the body 1100 allowing the liquor to push open the next valve 1115 and the to go through a swirl or backspinner at 1108 and then through the spray orifice 1109. The pump chamber 1106 progressively decreases in volume as the upstream seal 1133 closes in on it.

Liquor cannot escape through the valve 1133 as it is a one way valve that seals against the tube 1106 wall in that direction. Simultaneously, the diaphragm at 1131 moves inwards as does the prodder 1124 until all of the liquor has been discharged and this is shown in FIG. 12. After releasing the handle 1120 the resiliently deformable part of the flexible insert 1134 then causes the handle to return to its original position by pushing the prodder 1124 on the end of the trigger at 1121. Note that the handle itself could also be designed to deform as it is pulled and then to spring back into the original position once it is released. More spring force to reform the dispenser could be had from the end of the flexible insert 1131 which acts like a rolling diaphragm. As the pump chamber 1106 opens it tries to suck air in through the downstream valve 1115 but that seals against the tube wall 1106 in that direction preventing the air from entering the pump chamber 1106. It also sucks in liquor inside the chamber 1112 and via the diptube which is in the tubular chamber 1104 of the body 1100 through the upstream valve 1133 which readily gives way allowing the liquor to pass into the pump chamber 1106. Chamber 1112 is normally filled with liquor after the first few uses. The body 1100 has an integral collar that goes on the bottle neck and this has a thread 1102 but it could be any type of fitting and this could be a separate collar if required.

The flexible insert 1130 could be arranged vertically instead of horizontally with the trigger handle hinged on the body or cap and going over the body or cap instead of under or around it. The beauty of all of these versions is that the device is very small and simple so it is very cheap to make and assemble yet its performance will be amongst the best possible as there is so little dead space and the pump chamber is so close to the outlet nozzle. Another modification is to make the nozzle moveable and to have the handle connected to it so that as the handle is pulled inwards so is the downstream end of the flexible insert which is mounted horizontally as in FIG. 11. The nozzle can be mounted at any angle from vertical to below horizontal but we will consider horizontal as that is the most common direction in use. Moving the nozzle horizontally with the handle on a trigger is a technique that could be used with any trigger dispenser. Using the flexible insert horizontally is also ideal as the pump is very close to the spray orifice instead of a long way away as is often the case with standard triggers and as we have said earlier, this way is much more efficient. Since at least much of the pump is effectively outside of the bottle or container and the part inside the bottle is fairly small, it means very small bottle necks can be used again saving on cost.

Trigger dispensers in accordance with the present invention can be used in many configurations including as a dispenser, foamer and a spray pump. Having a small spout on the cap following the spray orifice would also produce a foam instead and a mesh in the spout could further enhance this. So different interchangeable pins on the cap tool could produce a wide range of products.

One of the big problems with pump dispensers, including trigger dispensers, is the range of discharge volumes and types of discharge required as this means different tools and assembly equipment has to be made which is very expensive. A wide range of discharge volumes could be produced with a dispenser in accordance with the present invention simply by varying the distance that the pump chamber or actuator is allowed to move or by compressing part of the chamber in its rest position. This could be done in a number of ways including having an upstream length of the flexible insert made variable on the tool, or by making the trigger prodder 1124 length variable on the tool, or by restricting the movement of the handle. The pump chamber 1106 diameter could also be made variable on the tool so a different flexible insert with a different diameter is used instead. But, this way the same body or cap and handle can be used and maybe one to three flexible inserts could cover a large range of discharges. The profile of the raised section on the inside of the cap for the precompression valve could also be made with interchangeable pins on the cap tool to achieve a range of different precompression levels.

Another problem with trigger dispensers is that they can easily be loosened by being knocked in transport by the user allowing the liquor to leak between the collar and bottle. Also, the bottles themselves are usually made for price so the bottle neck is often imperfect making the seal between the bottle and collar unreliable. For these reasons flexible sealing pads such as 1200 are often used and these are usually separate components but could be an over moulding. Unfortunately, these often don't actually maintain the seal if the cap has been accidentally loosened so we also seal inside the bottle neck by adding the annular plunger skirt 1201 to the pad 1200 and this will seal the bottle even if the collar is loose. As liquor is pumped from the bottle or vessel it needs to be replaced by air from outside and we then we would add fine grooves onto the underside of the sealing pad 1200 which let air past but little to no liquor. The sealing skirt 1201 will also allow the outside air in by deforming the sealing skirt 1201 away from the wall of the bottle neck yet will prevent the liquor from escaping there by sealing against the bottle neck as the liquor pressurises it. Sometimes, air will be allowed to refill the bottle through the flexible insert 101 and then the sealing skirt 1201 won't need to deform so it could be designed so it doesn't allow fluid through in either direction and an O ring shape would be an obvious example. These sealing ideas could just as easily be used on separate collars and could be used with any pump or trigger device.

Dual pumps or triggers are used to deliver two or more different fluids as a spray, foam or bolus of liquor and this could easily be achieved with this device by using a cap with two parallel chambers and one joined pair or two separate flexible inserts. For vertical pumps such as in FIGS. 2 and 3 the bottle could be split vertically in two creating 2 chambers with different liquor in each and 2 separate necks each shaped as the neck 100 and each next to each other. The actuator would have 2 corresponding tubes like the tube 118 also next to each other so when the actuator is on the bottle you create 2 pumps that are next to each other with each delivering different liquors. The diameters of the tubes and the flexible inserts will determine the volumes of each liquor dispensed and thus the ratio of them. The outlets of the tubes could be arranged so each dispenses the liquor in such a way that they mix in the air or the outlets could be joined into a common chamber so they mix prior to the final exit. The horizontal pumps would be very similar and would really only differ in that the liquor is discharged horizontally. Triggers would also be largely the same except the handle would have one or two prodders depending on if the flexible inserts are joined or separate. The flexible inserts could be mounted vertically or horizontally as in the previous versions. Two or more liquors could be delivered or one or more liquor and air and they could be delivered as a spray or as a dispenser or foam. The liquors would be in a split container or one could be in a container in the container and each would feed the chambers separately. Air would be drawn from the surroundings usually via the upstream end of the chamber holding the flexible insert and it would be sucked in past one way valves on by the flexible insert. The fluids could be joined in the air, at the end of the spouts, in the spouts or in a mixing chamber as required. They could be fed to the chambers via diptubes or the container could be used inverted or follower plates could be used to keep the fluids feeding the flexible inserts. The flexible pump member inserts could have different sized pump chambers to deliver a different ratio of the liquors but would normally but not necessarily, deliver them at the same pressure to ensure an even mixing.

Air could be delivered by the same flexible pump member insert that delivers the liquor and it could be mixed with that liquor before, after or inside the pump chamber. There could be two different pump chambers on one flexible insert with one for the air and this could be used to mix them at some point before the outlet.

As the flexible pump member insert is so simple and small, the pump can be very small and cheap and can be made in many different shapes, sizes and ways. It can be made as a spray pump or as a dispenser. It could be built into the neck or top of any squeezy container or a flexible bag, capsule, sachet or even a blister pack. This opens up the possibility of throw away pumps after one or several uses so could be used for products like glue and paint that would normally block up the nozzle after use. Or for pharmaceutical applications such as in hospitals where ideally it would only be used one or more times and then disposed of.

One of the many advantages of this pump design is that there is very little if any dead space either in the pump chamber or downstream of it. Normally, pumps use a hollow piston following the precompression valve and pump chamber and the piston is connected to an actuator which holds the swirl chamber. So the fluid travels from the chamber through the valve through the piston through the actuator into the swirl chamber and through the final orifice. After use, fluid is trapped in the piston, actuator and swirl chamber and the next time the pump is activated this is ejected first followed by the contents of the chamber less the retained fluid. The trapped fluid takes energy out of the system and has an adverse affect on the spray quality. Because our pump chamber is so close to the spray orifice and there is so little dead space, we have a very small amount of trapped fluid and consequently it has much less adverse affect on the spray quality. Also, the pumped fluid travels a much shorter distance which also normally takes a lot of energy out of the system.

The concept of having a pump adjacent to or substantially adjacent to the final outlet may be claimed independently of any other concepts disclosed in the present application.

FIGS. 13 to 17 show a more detailed version of a trigger dispenser in accordance with the present invention. It is comprised of an outer body 1300, a flexible pump member insert 1324, a nozzle 1370 and a trigger handle 1380 which are all joined together. This also shows an integral threaded collar 1310 that fixes onto a bottle or container but this could be a separate component instead. A diptube is normally used and this is held by friction in the tube 1311. This embodiment has been designed to have cheap and simple parts that are easy to make and assemble and combine to produce a quality device and a superior performance.

The body 1300 is normally moulded in a cheap plastic such as polypropylene and is also shown in FIG. 14. On the underside it has the threaded collar 1310 that fits onto the bottle and may also have a circular sealing ring that seals on the inside of the bottle neck. A tube 1312 protrudes from inside the collar 1310 and this takes a diptube for delivering the liquor from bottom of the container to the pump chamber 1325. A hollow ring protrusion 1308 extends from the back of the threaded collar 1310 and this rests on the web of the hand in use. The working part of the body mostly comprises 3 concentric tubes 1303, 1304 and 1306. The inner tube 1306 is connected to the feed tube 1312 that holds the diptube and the liquor is drawn through the diptube and then through tube 1312 and then through tube 1306. The middle tube 1306 has the flexible pump member in the downstream end and is connected to an inlet hole 1316 at the upstream end that leads to the inside of the bottle via the chamber 1317. The outer tube 1303 contains the nozzle 1370 as well as part of the flexible insert 1324. The body also has a cover 1302 that is hinged at 1313 usually by a thinned section in the polypropylene that creates a known hinge. On the other end it has a raised curved section and under it near the middle of the cover a flat curved plate 1320 and in the locked position the plate locks into a groove or recess 1402 made between the upstands 1403 and 1405 and shown in FIG. 14. In this position the front edges of the cover 1806 touches the nozzle at 1413 and prevents it from being moved backwards and thus stops the device being activated and functions as a lock. To open the lock the finger goes into a recess created between the front of the cover 1302 at 1321 and a recess in the nozzle at 1411 and lifts it slightly so the plate 1320 rests on the upstand 1403. In the locked position there is an interference fit between the plate 1320 and the upstand 1403 holding it in place.

The trigger handle 1380 is used to activate the device and it is held in place at 1305 by two integral pins 1503, 1503′ inside its two arms 1502 shown in FIG. 15 which go into the hole 1305 plus the cover 1302 then prevents the pins 1503, 1503′ from escaping from the hole 1305. The cover 1302 is capable of being hinged back through 90 degrees and in this position the handle can be snapped into place. The handle 1380 then pivots about 1305 between the cover 1302 and the outer tube 1303. As it is pulled inwards, the back of the arms at 1505 and 1505′ push two opposing pins 1412, 1412′ on the nozzle 1370 driving the nozzle backwards squashing the pump chamber 1325 and activating the device. The flexible pump member insert has resiliently deformable portion 1344 which acts as a spring around a through hole 1345 and this is deformed by the handle 1380 being pulled inwards and when the handle is released the two pins 1412, 1412′ on the nozzle 1370 in turn act on the handle at 1505 pushing it back into its original position. Sometimes an additional spring can be made with two arms on the trigger that join to a part of the body 1300 and are also bent as the handle is pulled inwards and these reform once the handle is released driving it back to its original position. Or an additional spring could be made of the nozzle 1370.

The nozzle 1370 goes inside of the outer tube 1303 and outside of the middle tube 1304 and it has two locating pegs 1412, 1412′ on opposite sides of its body that go into the two opposing slots in the body 1300 at 1401 and 1401′. The shape of the nozzle 1370 that is between the two tubes is tubular and it has two opposing ribs 1415 and 1415′ on the opposite face to reduce friction between it and the tubes. The nozzle 1370 forms a casing defining a cavity which houses the flexible pump member 1324 and the pump chamber is made between pump member 1324 and the nozzle 1370. The nozzle 1370 is moved inside the two tubes by the handle 1380 being pulled. The nozzle normally has an integral spray nozzle at the front at 1414 plus a swirl formed on the inside front face but it could also have a spray insert that is inserted at 1414 instead. It can also be used as a foamer when there would be an additional open tube downstream of the nozzle and sometimes superior foam would be produced by having two filters inside that tube. It could also be used as a dispenser where there would just be an open orifice at 1414 with no spray insert.

The flexible inset 1324 shown on FIGS. 13 and 16 is similar in construction and operation to that used in previous embodiments to which the reader should refer for details. The pump member 1324 has a central core 101a and first and second seal members 101b, 101c which define the pump chamber 1325 in the nozzle. The pump member also integrally forms the valves, swirl chamber, precompression valve 1343 and return spring 1344 of the dispenser either itself or between it and the nozzle 1370 or the body 1300. All of the valves are annular valves. The outlet post portion 1341 of the core acts as the back face of the swirl chamber which is either inserted at 1318 or more normally on the upstream face of the body at 1318. For non-spray dispensers there would be no post 1341 or a reduced one. There is a route 1354 around the post 1341 leading to chamber 1356 and then to valve 1355. This is a one way valve that allows liquor to go downstream to the final orifice but prevents air from getting upstream of it. The valve 1355 seals against the inside wall of the nozzle at 1342. Continuing upstream we see a protrusion 1602 in FIG. 16 on the flexible insert that sits in a recess in the nozzle and this is to hold the flexible part in the nozzle. We then go to chamber 1603 and then to the valve 1353 which has a sealing annular skirt 1352 at its leading edge which seals on the inside wall of the nozzle 1370 at 1601. This is a precompression valve and only allows the liquor to exit downstream when a set pressure has been reached and it allows nothing to pass upstream plus it acts as the pump chamber downstream wall. In between the two valves 1343 and 1355 is a hole 1340 in the flexible part and the resiliently deformable wall members of the core surrounding the hole form a spring at 1604 that allows the flexible part to collapse there and this becomes part of the precompression valve. Upstream of this valve is the pump chamber 1327 which is formed between the flexible parts and part of the inner nozzle wall. The centre of the pump chamber has the flexible pump member insert shaped to produce a spring at 1344 using an open section 1345. Next we see the valve 1346 which is a one way valve that allows liquor into the pump chamber but prevents any escaping from it and which also doubles as the upstream chamber wall. We then reach chamber 1324 and this is fed from an open tube (not shown) between it and chamber 1323. Then onto valve 1347 which is a one way valve that prevents anything in chamber 1324 escaping upstream. Then chamber 1326 and then valve 1348. Valves 1348 and 1347 combine to prevent anything passing up or downstream. We then reach valve 1349 which seals against the inside of the middle tube wall 1304 forming a one way seal that allows air to be pulled from the outside via chamber 1303 through to chamber 1304 and then to chamber 1317 and then to chamber 1310 and then into the bottle to replace any liquor discharged so the bottle or vessel doesn't collapse. Any liquor upstream of the valve is prevented from escaping by valve 1349 sealing on the outside of the middle wall 1304 and the other valves sealing against the nozzle walls. Sometimes gas can also build up inside the vessels and a vent is needed and valve 1349 can also fulfil this role by shaping the seal so that gas can escape through micro gaps but liquor cannot.

In use, the handle 1380 is pulled inwards and this pulls the nozzle 1370 inwards putting pressure on the flexible part 1324 to collapse at the two springs 1344 and 1604. The spring 1344 cannot collapse because the valve 1343 is sealing against the nozzle wall with 1352 so the spring 1604 collapses and pushes 1352 and 1343 away from the wall as it does so opening it and allowing the pump chamber 1327 to empty. On first operation all of the chambers are full of air so air is expelled initially and then replaced with liquor until they are all full of liquor and the pump is primed. Since the action of the device is the same we will assume that they are all full of liquor.

Once valve 1343 is open the spring 1344 starts to collapse as the hole 1345 closes and this forces liquor past the valve 1343 through to valve 1355 past the post 1351 and through the final orifice. The entire chamber empties as the hole 1345 collapses and virtually all of the liquor is discharged. Then the handle is released and the springs 1344 and 1604 try to reform and to push the nozzle and handle back to their rest positions. Because nothing can get upstream past valve 1355 liquor is sucked past valve 1346 from chamber 1324 then from chamber 1323 and then from the diptube in 1311 and then from the bottle itself. As it is drawn into the pump chamber so the springs both reform and a little is also drawn into chamber 1603 but not very much as it always contains some liquor as do the passages between it and the final orifice because there is nothing to eject these small volumes. Indeed one of the attractions of this device is how small a volume is retained. Soon, all chambers are again full of liquor. Any liquor drawn into the spring hole 1340 will be ejected each time and this will refill with liquor afterwards so it effectively becomes an auxiliary pump chamber although it is very small.

Other precompression designs could have been used instead of 1343 including some of those shown in the previous embodiments. The keys to this design are moving the nozzle inwards, having the flexible part do so many different jobs and using a low number of components and making them small and cheap whilst still delivering large doses and producing a quality performance.

In FIG. 3 we saw a simple pump made with the flexible part and two to three rigid components. FIGS. 18 and 19 show another even simpler version of the pump that uses a body and one or two flexible parts. This has been designed to be as cheap as possible and can be made so cheaply that it can be disposed off after one or several uses so that products like glues or paints or perishables can be readily used. But it can also be made to look very attractive and offers a new way of making pumps.

Its normal configuration would use a rigid or semi rigid body or casing 1801 and a single flexible pump member 1816 although each could be made bi-injection mouldings if preferred and they could even be made as one hinged part. If the flexible part is made as two parts it would probably be with the central part 1815 as one and the base part 1814 as another joined at 1821.

It would be activated by pressing the thumb or finger at 1817 with the fingers around the nozzle 1819 and those fingers or part of the hand on the top of the curved base around 1822 and 1822′. The flexible pump works as in all of the previous examples except the liquor is drawn from the holding reservoir 1813 to the pump chamber via the valve 1808 which is a one way valve that allows liquor to pass downstream but nothing passes upstream. It also forms the upstream wall of the pump chamber 1804.

The user presses on the base at 1817 which causes the flexible part to move inwards causing the chamber 1805 to empty and the core to collapse at emptying the pump chamber 1804 and driving any liquor to the final spray orifice 1802. Once the base is released at 1817 the resiliently deformable part of the core 1823 reforms as usual and the chamber is refilled via the valve 1808. As the reservoir 1813 empties the base is drawn in and this is enabled by the pleats 1818 so no air is needed to replace the liquor and it can be used through 360 degrees as liquor is always next to the valve 1808. Of course, it could be designed without a deformable base where you would allow air into the reservoir to replace the liquor. The dispenser could also be designed so that the inlet portion 1814 of the core is hollow and liquor is drawn up through it as normal.

The base could be welded onto the top using a flange 1812 or it could be designed to snap fit over the flange 1812 so no welding is needed. For cheap versions we envisage holding the device in a blister pack arrangement but others would need something on the spout 1819 to cover it and prevent the device being activated accidentally. You could used a hinged rigid cover that is hinged anywhere on the top 1801 or a separate part that is pushed onto the spout 1819 or you could extend the flexible base at 1820 and have a flexible top connected by a lanyard that is pushed over the spout and simultaneously protects and seals the orifice preventing actuation.

This device could be used to produce a spray or a bolus of liquor and could be used with any product. It could be made from very cheap materials such as polythene or expensive materials such as glass. It could even be used as part of a package such as a sandwich pack and could be used to pump out the air. The liquor could be discharged from the side of the spout rather than the top or even from the base. The reservoir could be sized to contain any volume from 0.1-50 mls and it could contain just liquor or liquor and air.

In FIG. 20 we see yet another version of a pump dispenser in accordance with the invention and this has several unique features compared to those previously shown and these could be used on any of the previous examples or they could be mixed with any of the previous features on this or the other versions. This is set up as a dispenser pump but it could just have easily been designed as a spray pump or a trigger could have been added. It is also very similar to the pump shown in FIG. 7 and could also be converted from existing pump tools.

One of the problems with pumps is that you really want a fast return so people can use the pump quickly and the fast return means you have to use a strong spring but this means the actuation force is high. If you also have a high discharge or a high precompression valve setting then these also require a high actuation force so the total actuation force becomes a problem. This is normally sorted out by using a long pump stroke combined with a smaller diameter pump plunger as the actuation force is proportional to the plunger diameter but so is the discharge. This is easy enough with a metal spring but is very difficult with these types of pumps where flexible plastic is used both as the spring and as the pump plunger. Our solution is to use a collapsible central core 2001 with more than one hole 2002, 2003, 2004, 2005 and 2006 where all or most of them are designed to collapse when force is applied to the actuator 2020 and then to reform when the force is released. The plastic in this core 2001 has to be minimised to reduce the cost of the plastic and the cycle time to mould it so this often means using ribs and small holes to produce the required spring action. As the core 2001 collapses it is designed to fill out the pump chamber 2022 in such a way that none of it pushes hard or jams against the side wall of the chamber 2022 and yet at the end of the pump stroke there is very little open or dead space left in the chamber 2022. This is essential as if the core pushes hard against the chamber wall the actuation force greatly increases and if there is a lot of dead space at the end of the stroke, the pump becomes very inefficient and the discharge volume is reduced. If only a small discharge is required then there may only need to be one collapsible hole in the flexible core 2001 inside the pump chamber 2022 as in previous examples.

This version also uses the precompression valve described in the trigger as shown in FIG. 13. This is ideal for dispensers as a low precompression is required and the precompression hole can be made quite large so the valve skirt seal 2007 is moved well away from the sealing collar 2023 in the actuator 2020 allowing easy passageway of the liquor to the spout outlet 2024. The flexible core 2001 is forcefully pushed onto a tubular plinth 2025 on the underside of the actuator 2020 where it is held in place by friction and by shaping the two parts. Another advantage of this valve is that if the liquor in the bottle is pressurised by some accident, the skirt seal 2007 pushes even harder against the sealing collar 2023 so the liquor cannot escape. Of course, any precompression valve could be used.

The inlet valve arrangement is also different and it uses either a side valve as previously described or a new poppet valve or a valve that combines both in one valve for maximum opening area. The poppet valve has a flexible concave collar 2032 that sits on a closed end rigid post 2032 made from one of parts of the rigid component 2030 and in this case from the collar part. The liquor flows into the post 2032 and out of the sides through one or more holes including 2033 into the chamber 2027 made between the core 2001 and the outside of the post 2032 and the meets the flexible concave collar 2012 which it pushes downstream away from the post 2032 creating a gap between the collar 2012 and the top of the post 2032 and flows through to the chamber 2006 and into the pump chamber 2022. If liquor or air tries to flow from the pump 2022 chamber back through to inside the post 2032 it simply causes the flexible collar 2012 to seal more tightly against the post 2032. The side valve works as before with the liquor flowing through the post 2032 into the chamber 2027 as with the poppet valve and then through holes in the wall of the core 2001 at 2008 (not shown) into the chamber 2028 between valves 2010 and 2011. Valve 2010 is designed not to give way so the liquor flows into the pump chamber 2022 on the return by valve 2011 giving way as before. Both the side valve and the poppet valve can be used simultaneously and this creates two gaps for the liquor to flow through making it ideal for larger flows or viscose liquors. Each valve could be used alone instead.

In previous embodiment such as those shown in FIGS. 1 and 7 we have tended to use two seals 106 and 107 upstream of the input valve to prevent liquor escaping and also air being drawn through to the pump chamber. But as these are low pressure seals they can be replaced with one seal 2010 instead as this can help reduce friction and makes it much easier to make the flexible component.

The single seal, poppet valve, poppet valve and combined side valve, shaped core spring could all be used on any of the previous versions or could be used in a number of different devices.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention.

1. A manually actuated pump type fluid dispenser comprising a casing defining an internal cavity and a pump member at least partly located in the cavity, the pump member having a central core and first and second seal members projecting radially outwardly of the core and spaced in an axial direction of the core for contact with the casing to define a pump chamber within the cavity in an area bounded by the first and second seal members, in which a region of the core between the first and second seal members is resiliently deformable from an initial resiliently biased configuration in which the first and second seal members are axially spaced by a first amount and an axially compressed configuration in which the seal members are spaced by a second amount which is less than the first amount to reduce the volume of the pump chamber and wherein the first and second seal members engage about opposing sides of the resiliently deformable region of the core when it is in the axially compressed configuration.

2. (canceled)

3. (canceled)

4. (canceled)

5. A manually actuated pump type fluid dispenser as claimed in claim 1, in which the resiliently deformable region of the core fills at least 80%, or more preferably 85%, or more preferably again 90%, even more preferably 95%, of the entire volume inside the cavity between the first and second seal members when it is axially compressed.

6. A manually actuated pump type fluid dispenser as claimed in claim 1, in which the resiliently deformable region of the core between the first and second seal members comprises at least one hole extending through the core, the core having resiliently deformable wall portions surrounding the through hole, the arrangement being configured such that the hole is substantially closed when the resiliently deformable region is compressed.

7. (canceled)

8. (canceled)

9. (canceled)

10. (canceled)

11. (canceled)

12. (canceled)

13. (canceled)

14. A manually actuated pump type fluid dispenser as claimed in claim 1, in which the casing and the pump member are moveable relative to one another between a rest position in which the resiliently deformable region of the core between the first and second seal members is in its initial resiliently biased configuration and an actuated position in which the region of the core between the first and second seal members is axially compressed.

15. A manually actuated pump type fluid dispenser as claimed in claim 1, in which the first seal member is located at the downstream end of the pump chamber and is operative as a pre-compression pump chamber release valve, allowing fluid to exit the pump chamber only when the fluid is at or above a pre-determined dispensing pressure.

16. A manually actuated pump type fluid dispenser as claimed in claim 15, in which the casing and the pump member are moveable relative to one another between a rest position in which the resiliently deformable region of the core between the first and second seal members is in its initial resiliently biased configuration and an actuated position in which the region of the core between the first and second seal members is axially compressed, and wherein the first seal member comprises a seal portion for engagement with the casing, the casing having formations which are positioned so as to deflect the seal portion and open a flow path from the pump chamber to an outlet orifice of the dispenser when a predetermined force is applied to the casing to move it from the rest position towards the actuated position.

17. A manually actuated pump type fluid dispenser as claimed in claim 16, in which the core comprises a further resiliently deformable region compressible in an axial direction and which is axially spaced from the pump chamber, the further resiliently deformable portion being configured to deform from an initial resilient biased configuration to an axially compressed configuration to enable relative movement between the casing and the pump member from the rest position by the predetermined amount required to open the flow path during actuation of the dispenser in use.

18. A manually actuated pump type fluid dispenser as claimed in claim 1, in which the second seal member is located at the upstream end of the pump chamber and is configured to act as an inlet valve member to enable a fluid to be dispensed to be drawn into the pump chamber.

19. A manually actuated pump type fluid dispenser as claimed in claim 18, in which the second seal member comprises two axially spaced flexible seal portions defining an inlet chamber between themselves and the casing, a downstream one of the flexible seal portions being resiliently biased into contact with the casing but moveable in a downstream direction away from the casing to allow fluid to flow from the inlet chamber into the pump chamber but not in the reverse direction.

20. A manually actuated pump type fluid dispenser as claimed in claim 19, in which the other flexible sealing portion is resiliently biased into contact with the casing to prevent fluid flowing between itself and the casing from the inlet chamber.

21. (canceled)

22. A manually actuated pump type fluid dispenser as claimed in claim 1, in which part of the core comprises an inlet portion extending in an upstream direction from the second seal member, the inlet portion having one or more inlet passages defined therein for directing fluid to the pump chamber, the inlet portion being configured for mounting in one of: a) a passage defined in a body which forms an outlet from a container for holding a liquid to be dispensed and b) an outlet opening in a neck ion of a container for a fluid to be dispensed, the inlet portion including at least one seal member for contact with a surface of body defining the passage or the neck of the container.

23. (canceled)

24. (canceled)

25. (canceled)

26. A manually actuated pump type fluid dispenser as claimed in claim 22, in which the seal is resiliently deformable in a direction away from the surface to allow air to enter the container when the pressure in the container is lower than the ambient air pressure.

27. (canceled)

28. A manually actuated pump type fluid dispenser as claimed in claim 1, in which the dispenser has at least one final outlet orifice and an outlet fluid flow path fluidly connecting the pump chamber to the outlet and in which the at least one final outlet orifice is provided in a wall of the casing, an outlet end portion of the core being received in a recess in an inner side of the wall adjacent the outlet orifice at least part of the outlet fluid pathway being formed between the surface of the casing defining the recess and the outlet end portion on the pump member.

29. (canceled)

30. A manually actuated pump type fluid dispenser as claimed in claim 28, in which a swirl chamber is formed between the pump member and casing adjacent the outlet orifice, the swirl chamber being configured to cause fluid flowing into it from the pump chamber to rotate about an axis of the orifice, wherein features defining the swirl chamber are integrally formed on at least one of the outlet end portion of the core of the pump member and the casing.

31. (canceled)

32. (canceled)

33. (canceled)

34. A manually actuated pump dispenser as claimed in claim 1, in which the dispenser comprises a trigger actuator.

35. (canceled)

36. (canceled)

37. (canceled)

38. (canceled)

39. (canceled)

40. A manually actuated pump type fluid dispenser comprising a casing defining an internal cavity and an outlet orifice, the dispenser further comprising a pump member at least partly located in the cavity to define a pump chamber, the pump member having an outlet post portion having an axial end which is positioned adjacent a wall portion of the casing in which the outlet orifice is defined, the axial end of the post portion having features defining a swirl chamber between itself and the wall portion.

41. A manually actuated pump type fluid dispenser as claimed in claim 40, in which the post portion is received in a recess defined by the casing.

42. A manually actuated pump type fluid dispenser as claimed in claim 40, in which the pump member is a moulded component and the features defining the swirl chamber are formed integrally with the post portion.

43. A manually actuated pump type fluid dispenser as claimed in claim 40, in which the pump member is a moulded component and the features defining the swirl chamber are formed integrally with the casing.

44. A manually actuated pump type fluid dispenser as claimed in claim 40, in which the outlet post portion is cylindrical and is received in a cylindrical recess in the casing, the recess being closed at one end by means of the wall portion containing the outlet orifice, one or more fluid passageways being defined between a side wall region of the recess and a side wall region of the outlet post portion through which fluid (liquid) can pass to reach the outlet orifice from the pump chamber.

45. (canceled)

46. (canceled)
